(19) United States
(12) Patent Application Publication
(10) Pub. No.: US 2019/0237085 A1
(43) Pub. Date: Aug. 1, 2019

(54) DISPLAY APPARATUS AND METHOD FOR DISPLAYING SCREEN OF DISPLAY APPARATUS

(71) Applicant: SAMSUNG ELECTRONICS CO., LTD., Suwon-si (KR)

(72) Inventors: Young-jun RYU, Suwon-si (KR); Myung-jae KIM, Suwon-si (KR); Ji-bum MOON, Seoul (KR); Kye-rim LEE, Seoul (KR); Eun-jin LEE, Seoul (KR)

(73) Assignee: SAMSUNG ELECTRONICS CO., LTD., Suwon-si (KR)

(21) Appl. No.: 16/022,058

(22) Filed: Jun. 28, 2018

(30) Foreign Application Priority Data
Jan. 29, 2018 (KR) 10-2018-0010763

(51) Int. Cl. G10L 17/22; G10L 15/30; G06F 3/16; G10L 15/22

(52) U.S. Cl. CPC G10L 17/22; G10L 15/30; G10L 2015/223; G10L 15/22; G06F 3/167

(57) ABSTRACT

A display apparatus and a method for displaying a screen of the display apparatus are provided. The display apparatus includes a display; a communication interface configured to be connected to each of a remote controller and a voice recognition server; and a processor configured to control the display and the communication interface. The processor is further configured to control the communication interface to, based on receiving a signal that corresponds to a user voice from the remote controller, transmit the signal to the voice recognition server, and based on receiving a voice recognition result that relates to the user voice from the voice recognition server, perform an operation that corresponds to the voice recognition result and control the display to display a recommendation guide that provides guidance for performing a voice control method related to the operation.

### CROSS-REFERENCE TO RELATED APPLICATIONS

This application is based on and claims priority under 35 U.S.C. § 119 to Korean Patent Application No. 10-2018-0010763, filed on Jan. 29, 2018, in the Korean Intellectual Property Office, the disclosure of which is incorporated herein by reference in its entirety.

### BACKGROUND

### 1. Field

The disclosure relates to a display apparatus and a method for displaying a screen of a display apparatus and more particularly, to a display apparatus which provides an active user guide in response to voice recognition and a method for displaying a screen of the display apparatus.

### 2. Description of the Related Art

A panel key or a remotely controlled processor of a display apparatus is widely used as an interface between a user and a display apparatus that is capable of outputting contents as well as broadcasting content. Further, a user voice or a user motion can be used as an interface between a display apparatus and a user.

With the development of technology, the functions of a display apparatus have become complicated (e.g., various application execution, game execution, etc.), and it has become possible to execute various contents, such as moving images, which can be downloaded from the outside, and/or to browse the Internet.

In response to a display apparatus which has become more complicated and diverse, the number of potential user's voice commands is also increasing. Thus, there is a need for providing an active user guide that is suitable for operation in conjunction with a high-performance display apparatus that is capable of using voice input.

### SUMMARY

In accordance with an aspect of the disclosure, there is provided a display apparatus including: a display, a communication interface configured to be connected to each of a remote controller and a voice recognition server and a processor configured to control the display and the communication interface. The processor is further configured to control the communication interface to, based on receiving a signal that corresponds to a user voice from the remote controller, transmit the signal to the voice recognition server, and, based on receiving a voice recognition result that relates to the user voice from the voice recognition server, to perform an operation that corresponds to the voice recognition result and to control the display to display a recommendation guide that provides guidance for performing a voice control method related to the operation.

The display apparatus may further include a storage configured to store history information that corresponds to a voice utterance history for at least one user, and the processor may be further configured to determine the recommendation guide based on the history information.

The processor, based on a same voice recognition result being received from the voice recognition server, may be further configured to control to display another recommendation guide according to an authenticated user based on the history information.

The processor may be further configured to control the display to display a first voice user interface based on a reception of a signal that corresponds to the user voice, a second voice user interface based on a transmission of the received signal to a voice recognition server, and a third voice user interface based on a reception of the voice recognition result.

The display apparatus may further include a microphone, and the processor may be further configured to control the communication interface to transmit a signal that corresponds to a user voice which is received via the microphone to the voice recognition server.

The processor may be further configured to control the display to display the voice user interface distinctively with respect to contents displayed on the display.

The processor may be further configured to control the display to display different voice user interfaces based on a reception of a signal that corresponds to the user voice, a transmission of the received signal to a voice recognition server, and a reception of the voice recognition result, respectively.

In accordance with an aspect of the disclosure, there is provided a method for displaying a screen of a display apparatus in the display apparatus which is connected to a remote controller and a voice recognition server, the method including: displaying a first voice user interface that corresponds to a selection of a voice button received from the remote controller, receiving a signal that corresponds to a user voice from the remote controller, transmitting a packet that corresponds to the received signal to the voice recognition server, displaying a second voice user interface that corresponds to a voice recognition result received from the voice recognition server, performing an operation that corresponds to the voice recognition result, and displaying a recommendation guide that provides guidance for performing a voice control method related to the operation.

The recommendation guide may be displayed on one side of a screen of the display apparatus.

The method may further include determining the recommendation guide based on history information that corresponds to a pre-stored voice utterance history of a user.

The recommendation guide may be provided variably based on an authenticated user.

The first voice user interface, the second voice user interface and the recommendation guide may be displayed in an overlapping manner with respect to a content displayed on the display apparatus.

In accordance with an aspect of the disclosure, there is provided a display apparatus including: a display, a communication interface configured to be connected to a remote controller, and a processor configured to control the display and the communication interface. Based on when the communication interface receives a user voice signal via the remote controller, the processor is further configured to execute a voice recognition algorithm with respect to the received user voice signal in order to obtain a voice recognition result, to perform an operation that corresponds to the voice recognition result, and to control the display to display a recommendation guide that provides guidance for performing a voice control method related to the operation.

The display apparatus may further include a storage configured to store history information that corresponds to a voice utterance history for at least one user. The processor may be further configured to determine the recommendation guide based on the history information.

When the received user voice signal relates to a volume increase or a volume decrease and the operation relates to a corresponding change of volume, the recommendation guide may include guidance for setting a volume to a numerical level selected by a user. When the received user voice signal relates to a channel increase or a channel decrease and the operation relates to a corresponding change of channel, the recommendation guide may include guidance for setting a channel to a numerical value selected by a user.

In accordance with an aspect of the disclosure, there is provided a method for displaying a screen of a display apparatus which is connected to a remote controller, the method including: displaying a first voice user interface that corresponds to a selection of a voice button received from the remote controller; receiving a signal that corresponds to a user voice from the remote controller; executing a voice recognition algorithm with respect to the received signal in order to obtain a voice recognition result; displaying a second voice user interface that corresponds to the obtained voice recognition result; performing, with respect to the display apparatus, an operation that corresponds to the voice recognition result; and displaying a recommendation guide that provides guidance for performing a voice control method related to the operation.

The method may further include determining the recommendation guide to be displayed based on history information that corresponds to a pre-stored voice utterance history of a user.

When the received signal relates to a volume increase or a volume decrease and the operation relates to a corresponding change of volume, the recommendation guide may include guidance for setting a volume to a numerical level selected by a user. When the received signal relates to a channel increase or a channel decrease and the operation relates to a corresponding change of channel, the recommendation guide includes guidance for setting a channel to a numerical value selected by a user

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic view illustrating an operation among a display apparatus, a remote controller and a server, according to an embodiment;

FIG. 2 is a block diagram illustrating a display apparatus and a remote controller, according to an embodiment;

FIG. 3 is a schematic flowchart illustrating a method for displaying a screen of a display apparatus, according to an embodiment;

FIGS. 4A, 4B, 4C, 4D, 4E, 4F, 4G, 4H, and 4I are schematic views illustrating examples of a method for displaying a screen of a display apparatus, according to an embodiment;

FIG. 5 is a schematic view illustrating an example of a recommended voice data list that corresponds to voice data, according to an embodiment; and

FIGS. 6A, 6B, 6C, 6D, 6E, and 6F are schematic views illustrating examples of a method for controlling a screen of a display apparatus, according to embodiments.

### DETAILED DESCRIPTION

Hereinafter, embodiments of the disclosure will be described in detail with reference to the accompanying drawings. In addition, a method of manufacturing and using an electronic apparatus according to an embodiment will be described with reference to the accompanying drawings. In the drawings, same reference numerals or symbols refer to parts or elements which perform substantially the same functions.

As used herein, the terms “1st” or “first” and “2nd” or “second” may use corresponding components regardless of importance or order and are used to distinguish one component from another without limiting the components. The terms used herein are solely intended to explain specific example embodiments, and not to limit the scope of the present disclosure. For example, the first element may be referred to as the second element and similarly, the second element may be referred to as the first element without going beyond the scope of rights of the present disclosure. As used herein, the term “and/or,” includes any or all combinations of one or more of the associated listed items. Further, as used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

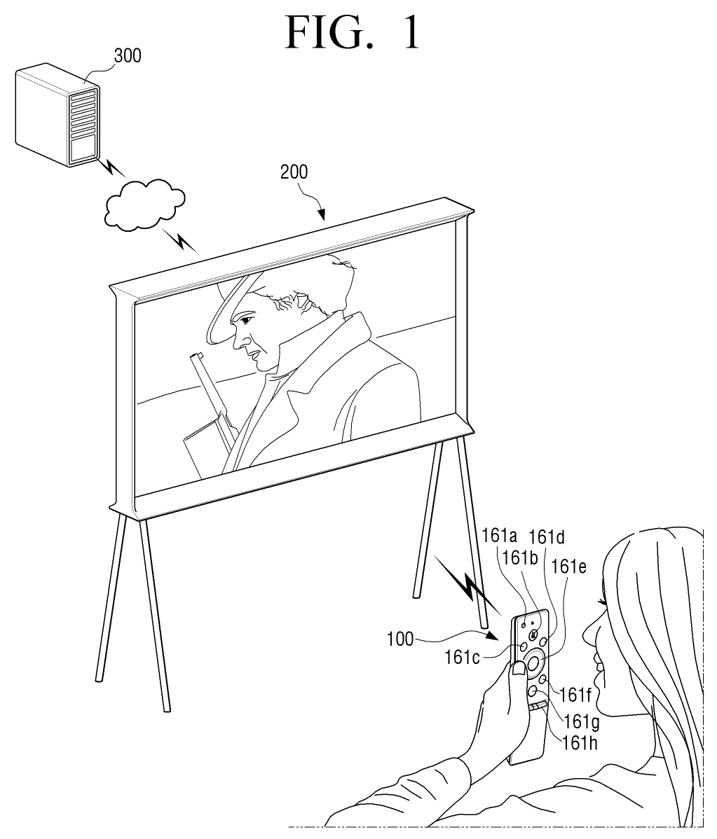

According to an embodiment, a “selection of a button (or key)” on a remote controller 200 (refer to FIG. 1) may be used as a term that refers to a pressing of the button (or key) or a touching of the button (or key). The expression “user input” as used herein may refer to a concept that includes, for example, a user selecting a button (or key), pressing a button (or key), touching a button, making a touch gesture, a voice or a motion.

According to an embodiment, “a screen of a display apparatus” may be used as a term that includes a display of the display apparatus.

Terms used in the present specification are used only to describe specific exemplary embodiments rather than limiting the present disclosure. Singular forms are intended to include plural forms unless the context clearly indicates otherwise. Throughout this specification, it will be understood that the terms “comprise” and “include” and variations thereof, such as “comprising,” “comprises,” “including,” and “includes,” specify the presence of features, numbers, steps, operations, components, parts, or combinations thereof, described in the specification, but do not preclude the presence or addition of one or more other features, numbers, steps, operations, components, parts, or combinations thereof.

Like reference numerals proposed in each drawing denote like components.

FIG. 1 is a schematic view illustrating an operation among a display apparatus, a remote controller and a server, according to an embodiment.

FIG. 1 illustrates a display apparatus, a remote controller and one or more servers.

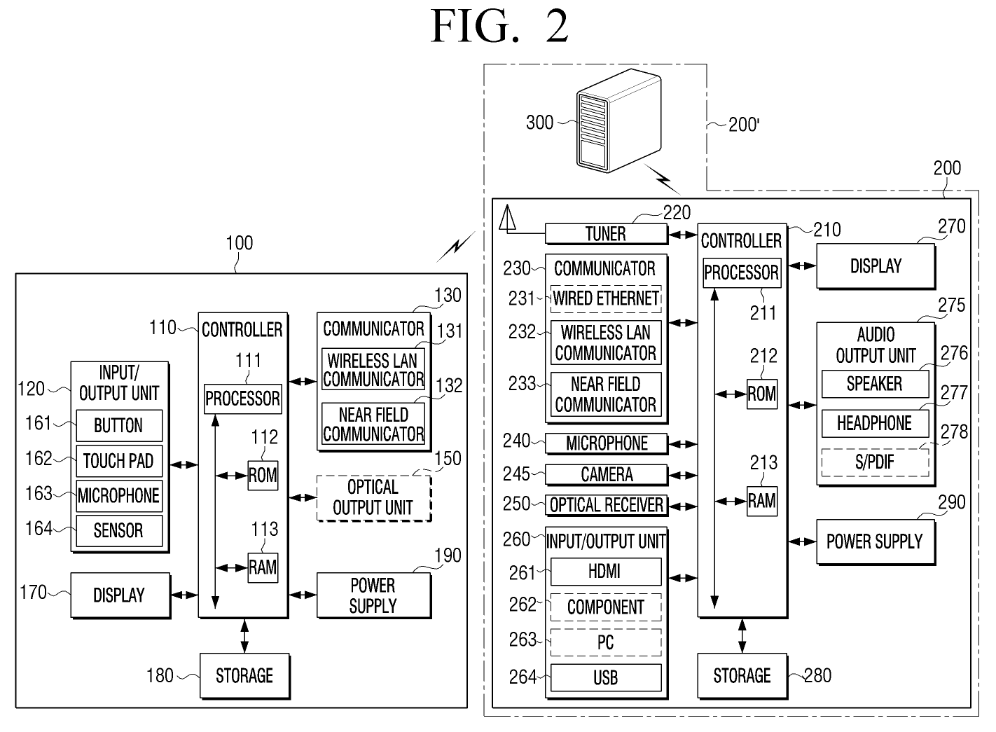

A display apparatus 200 capable of outputting a content as well as broadcasting content may receive a user voice using a built-in or connectable microphone 240 (referring to FIG. 2). In addition, the remote controller 100 may receive a user voice using a microphone 163 (referring to FIG. 2).

The remote controller 100 may output (or transmit) a control command by using infrared or near field communication (e.g., Bluetooth, etc.) to control the display apparatus 200. In addition, the remote controller 100 may convert a voice received via infrared or near field communication (e.g., Bluetooth, etc.) and transmit the converted voice to the display apparatus 200.

A user may control the functions of the display apparatus 200 (e.g., power on/off, booting, channel change, volume adjustment, content playback, etc.) by selecting a key (including a button) on the remote controller 100 and by performing a motion (recognition) that serves as a user input (e.g., a touch (gesture) via a touch pad, voice recognition via the microphone 163 or motion recognition via a sensor 164 (refer to FIG. 2)).

A user may control the display apparatus 200 by using a voice. The microphone 163 of the remote controller 100 may receive a user voice that corresponds to the control of the display apparatus 200. The remote controller 100 may convert a received voice into an electrical signal (e.g., digital signal, digital data or packet) and transmit the same to the display apparatus 200.

A user may control the display apparatus 200 (e.g., power on/off, booting, channel change, volume adjustment, content playback, etc.) with motion recognition by using a camera 245 (referring to FIG. 2) attached to the display apparatus. In addition, a user may control the screen of the display apparatus 200 by using a movement of the remote controller 100 (e.g., by gripping or moving the remote controller 100).

Referring to FIGS. 1 and 2, the remote controller 100 includes a button 161 (or a key) that corresponds to at least one function and/or operation of the display apparatus 200. The button 161 may include a physical button or a touch button. In addition, the remote controller 100 may include a single-function button (e.g., 161a, 161b, 161c, 161d, 161e, 161f, 161g) and/or a multi-function button (e.g., 161h) that corresponds to the functions performed in the display apparatus 200.

Each single function button of the remote controller 100 (e.g., power button 161a and pointer key 161e) may refer to a key that corresponds to the control of one function from among a plurality of functions performed in the display apparatus 200. The keys of the remote controller 100 may be single function keys in most cases.

The arrangement order and/or the number of buttons of the remote controller 100 may be increased, changed, or reduced according to the functions of the display apparatus 200.

A voice recognition server 300 may convert an electrical signal (or a packet that corresponds to the electronic signal) that corresponds to a user voice input at the remote controller 100 or the display apparatus 200 into voice data (e.g., text, code, etc.) which is generated by using voice recognition. The converted voice data may be transmitted to a second server (not shown) via the display apparatus 200 or may be directly transmitted to the second server.

An interactive server (not shown) may control the converted voice data into control information (e.g., a control command for controlling the display apparatus 200) which can be recognized in the display apparatus 200. The converted control information may be transmitted to the display apparatus 200.

A detailed description regarding the voice recognition server 300 and the interactive server will be provided below.

FIG. 2 is a block diagram illustrating a display apparatus and a remote controller, according to an embodiment.

Referring to FIG. 2, the display apparatus 200 which receives an electrical signal that corresponds to a user voice from the remote controller 100 may be connected with an external apparatus (e.g., the server 300, etc.) in a wired or wireless manner by using a communicator (also referred to herein as a “communication interface”) 230 and/or an input/output unit (also referred to herein as an “input/output component”) 260.

The display apparatus 200 which receives an electrical signal that corresponds to a user voice from the remote controller 100 may transmit the received electronic signal (or a packet that corresponds to the electrical signal) to an external apparatus (e.g., server 300, etc.) connected in a wired or wireless manner by using a communicator 230 or an input/output unit 260. The external apparatus may include any of a mobile phone (not shown), a smart phone (not shown), a tablet personal computer (PC) (not shown), and a PC (not shown).

The display apparatus 200 may include a display 270, and may additionally include at least one of a tuner 220, the communicator 230 and the input/output unit 260. The display apparatus 200 may include the display 270, and may additionally include a combination of the tuner 220, the communicator 230 and the input/output unit 260. Further, the display apparatus 200 including the display 270 may be electrically connected to a separate electronic apparatus (not shown) including a tuner (not shown).

The display apparatus 200, for example, may be implemented to be any one of an analog television (TV), digital TV, 3D-TV, smart TV, light emitting diode (LED) TV, organic light emitting diode (OLED) TV, plasma TV, monitor, curved TV having a screen (or display) of fixed curvature, flexible TV having a screen of fixed curvature, bended TV having a screen of fixed curvature, and/or curvature modifiable TV in which the curvature of the current screen can be modified by a received user input. However, it will be apparent to persons having ordinary skill in the art that the display apparatus 200 is not limited to the above.

The display apparatus 200 may include the tuner 220, the communicator 230, a microphone 240, a camera 245, an optical receiver 250, the input/output unit 260, the display 270, an audio output unit 275, a storage 280 and a power supply 290. The display apparatus 200 may include a sensor (e.g., an illuminance sensor, a temperature sensor, or the like (not shown)) that is configured to detect an internal state or an external state of the display apparatus 200.

TA controller 210 may include a processor (e.g., a central processing unit (CPU)) 211, a read-only memory (ROM) 212 (or non-volatile memory) for storing a control program for the controlling of the display apparatus 200, and random access memory (RAM) 213 (or volatile memory) for storing signals or data input outside the display apparatus 200 or used as a storing area in correspondence with the various operations performed in the display apparatus 200.

The controller 210 controls the general operations of the display apparatus 200 and signal flows between internal elements 210-290 of the display apparatus 200, and processes data. The controller 210 controls power supplied from the power supply 290 to internal elements 210-290. Further, when there is a user input, or when a predetermined condition which has been stored previously is satisfied, the controller 210 may execute an OS (Operation System) or various applications stored in the storage 280.

The processor 211 may further include a graphics processing unit (GPU, not shown) that is configured for graphics processing that corresponds to an image or a video. The processor 211 may include a graphics processor (not shown), or a graphics processor may be provided separately from the processor 211. The processor 211 may be implemented to be an SoC (System On Chip) that includes a core (not shown) and a GPU. In addition, the processor 211 may be implemented to be a SoC that includes at least one of the ROM 212 and the RAM 213. The processor 211 may include a single core, a dual core, a triple core, a quad core, or a greater number of cores.

The processor 211 of the display apparatus 200 may include a plurality of processors. The plurality of processors may include a main processor (not shown) and a sub processor (not shown) which operates in a screen off (or power off) mode and/or a pre-power on mode, in accordance with one of the states of the display apparatus 200. The plurality of processors may further include a sensor processor (not shown) for controlling a sensor (not shown).

The processor 211, the ROM 212, and the RAM 213 may be connected with one another via an internal bus.

The controller 210 controls a display 270 that is configured for displaying a content and a communicator 230 that is connected to a remote controller 100 and a voice recognition server 300. If a user voice is received from the remote controller 100 via the communicator 230, the controller 210 transmits a signal that corresponds to the received user voice to the voice recognition server 300. If a voice recognition result regarding the user voice is received from the voice recognition server 300 via the communicator 230, the controller 210 performs an operation that corresponds to the voice recognition result. For example, if a user voice of “volume up” is recognized, the operation of displaying a GUI that represents the recognition result, and an operation of increasing a voice output level, etc. may be performed sequentially or in parallel. The controller 210 controls the display 270 to display a recommendation guide that provides guidance for performing a voice control method related to the operation that corresponds to the voice recognition result. For example, the processor 210 may control the display 270 to display a recommendation guide that provides guidance that if a specific level (e.g., volume 15) is uttered instead of using the method of increasing a volume level incrementally, the volume level may be changed to volume level 15 immediately.

In addition, the processor 210 controls the display to display another recommendation guide based on a voice recognition result and history information. The history information refers to information obtained by collecting a respective voice utterance history for each user from among a plurality of users, and may be stored in the storage 280. The processor 210 may update the history information stored in the storage 280 at any time or periodically.

If the same voice recognition result is received from the voice recognition server, the controller 210 may control to display the another recommendation guide based on the history information.

If the same voice recognition result is received from the voice recognition server, the controller 210 may control to display the another recommendation guide according to an authenticated user based on the history information.

The recommendation guide may be received from an external server, or may be stored in the storage 280 in advance. According to an embodiment, if a recommendation guide is received from an external server, the controller 210 may transmit a voice recognition result to the corresponding server, and receive at least one recommendation guide that corresponds to the voice recognition result and operation information that corresponds to the recommendation guide. The controller 210 controls the display 270 to display at least one of the received recommendation guides. If a user voice input later corresponds to the recommendation guide, the controller 210 performs an operation based on the operation information that corresponds to the recommendation guide.

The controller 210 may control the display to display different respective voice user interfaces in accordance with a reception of a signal that corresponds to the user voice, a transmission of the received signal to a voice recognition server, and a reception of the voice recognition result.

The controller 210 may control to transmit a signal that corresponds to a user voice received via a microphone to the voice recognition server via the communicator.

The controller 210 may control to display the voice user interface distinctively with respect to the content.

According to an embodiment, the term “the processor of the display apparatus 200” may include the processor 211, the ROM 212, and the RAM 213 of the display apparatus 200. According to an embodiment, the term “the processor of the display apparatus 200” may refer to the processor 211 of the display apparatus 200. Alternatively, the term “the processor of the display apparatus 200” may include the main processor, the sub processor, the ROM 212 and the RAM 213 of the display apparatus 200.

It shall be easily understood by a person having ordinary skill in the art that the configuration and the operation of the controller 210 may be implemented in any of various implementations according to an embodiment.

The tuner 220 may tune and select only the channel frequency to be received by the display apparatus 200 from among the various wave components via the amplification, the mixing and the resonance of broadcast signals which are received in a wired or wireless manner. The broadcast signals include a video signal, an audio signal, and additional data signal(s) (e.g., a signal that includes an Electronic Program Guide (EPG)).

The tuner 220 may receive video, audio, and data in a frequency band that corresponds to a channel number (e.g., cable broadcast channel No. 506) based on a user input (e.g., voice, motion, button input, touch input, etc.).

The tuner 220 may receive a broadcast signal from any of various sources, such as a terrestrial broadcast provider, a cable broadcast provider, a satellite broadcast provider, an Internet broadcast provider, etc.

The tuner 220 may be implemented in an all-in-one type with the display apparatus 200, or may be implemented as a tuner (not shown) that is electrically connected to the display apparatus 200 or a separate device that includes a tuner (not shown) (e.g., set-top box or one connect).

The communicator 230 may connect the display apparatus to the remote controller or the external apparatus 300 under the control of the communicator 230. The communicator 230 may transmit an electrical signal (or a packet that corresponds to the electrical signal) that corresponds to a user voice to the first server 300 or receive voice data that corresponds to an electrical signal (or a packet that corresponds to the electrical signal) from the first server 300 under the control of the processor 210. In addition, the communicator 230 may transmit received voice data to the second server (not shown) or receive control information that corresponds to voice data from the second server under the control of the processor 210.

The communicator 230 may download an application from outside or perform web browsing under the control of the processor 210.

The communicator 230 may include at least one of a wired Ethernet 231, a wireless local area network (LAN) communicator 232, and a near field communicator 233. In addition, the communicator 230 may include a combination of the wired Ethernet 232, the wireless LAN communicator 232 and the near field communicator 233.

The wireless LAN communicator 232 may be connected with an access point (AP) wirelessly in a place where the AP is installed under the control of the processor 210. The wireless LAN communicator 232 may include wireless fidelity (WiFi), for example. The wireless LAN communicator 232 supports the wireless LAN standards (IEEE802.11x) of the Institute of Electrical and Electronics Engineers (IEEE). Further, the near field communicator 233 may perform the near field communication between the remote controller 100 and an external device wirelessly without an AP under the control of the processor 210. The near field communication may include any of Bluetooth, Bluetooth low energy, infrared data association (IrDA), ultra wideband (UWB), and/or near field communication (NFC), for example.

The communicator 230 according to an embodiment may receive a control signal transmitted by the remote controller 100. In addition, the near field communicator 233 may receive a control signal transmitted by the remote controller 100 under the control of the processor 210.

The microphone 240 receives an uttered user voice. The microphone 240 may convert the received voice into the electrical signal and output the electrical signal to the processor 210. The user voice may include the voice that corresponds to the menu of the display apparatus 200 or the function control, for example. The recognition range of the microphone 240 may vary based on the level of a user's voice and a surrounding environment (e.g., a speaker sound, ambient noise, or the like).

The microphone 240 may be implemented in an all-in-one type with the display apparatus 200, or may be implemented separately from the display apparatus 100 as a separate device. The separate microphone 240 may be electrically connected with the display apparatus 200 via the communicator 230 or the input/output unit 260.

The camera 245 may photograph a video (e.g., continuous frames) in a camera recognition range. For example, the user motion may include the presence of the user (e.g., the user appears within the camera recognition range), a part of the user's body, such as user's face, look, hand, fist, or finger, and/or a motion of a part of the user's body. The camera 245 may include a lens (not shown) and an image sensor (not shown).

The camera 245 may be disposed, for example, on one of the upper end, the lower end, the left, and the right of the display apparatus 200.

The camera 245 may convert the photographed continuous frames and output the converted frames to the processor 210. The processor 210 may analyze the photographed continuous frames in order to recognize a user motion. The processor 210 may display a guide or a menu on the display apparatus 200 using the motion recognition result, or the processor 210 may perform a control operation that corresponds to the motion recognition result (e.g., a channel change operation or a volume adjustment operation).

If there are multiple cameras 245, the processor 210 may receive a three-dimensional still image or a three-dimensional motion via the plurality of cameras 245.

The camera 245 may be implemented in an all-in-one type with the display apparatus 200, or may be implemented separately from the display apparatus 100 as a separate device. The electronic apparatus (not shown) including the separate camera (not shown) may be electrically connected to the display apparatus 200 via the communicator 230 or the input/output unit 260.

The optical receiver 250 may receive an optical signal (including a control information) output from the remote controller 100 via an optical window (not shown).

The optical receiver 250 may receive an optical signal that corresponds to a user input (e.g., touching, pressing, touch gestures, a voice or a motion) from the remote controller 100. A control signal may be obtained from the received optical signal. The received optical signal and/or the obtained control signal may be transmitted to the processor 210.

The input/output unit 260 may receive a content from outside the display apparatus 200 under the control of the processor 210. For example, the content may include any of a video, an image, a text, or a web document.

The input/output unit 260 may include one of a High Definition Multimedia Interface (HDMI) port 261, a component input jack 262, a PC input port 263, and a Universal Serial Bus (USB) input jack 264, which correspond to reception of the content. The input/output unit 260 may include a combination of the HDMI input port 262, the component input jack 262, the PC input port 263, and the USB input jack 264. It would be easily understood by a person having ordinary skill in the art that the input/output unit 260 may be added, deleted, and/or changed based on performance and configuration of the display apparatus 200.

The display 270 may display the video included in the broadcast signal received via the tuner 220 under the control of the processor 210. The display 270 may display a content (e.g., a video) input via the communicator 230 or the input/output unit 260. The display 270 may output a content stored in the storage 280 under the control of the processor 210. In addition, the display 270 may display a voice user interface (UI) to perform a voice recognition task that corresponds to voice recognition, or a motion UI to perform a motion recognition task that corresponds to motion recognition. For example, the voice UI may include a voice command guide and the motion UI may include a motion command guide.

The screen of the display apparatus 200 according to an embodiment may display a visual feedback that corresponds to the display of a recommendation guide under the control of the processor 210.

The display 270 according to another embodiment may be implemented separately from the display apparatus 200. The display 270 may be electrically connected with the display apparatus 200 via the input/output unit 260 of the display apparatus 200.

The audio output unit 275 outputs an audio included in a broadcast signal received via the tuner 220 under the control of the processor 210. The audio output unit 275 may output an audio (e.g., an audio that corresponds to a voice or a sound) input via the communicator 230 or the input/output unit 260. In addition, the audio output unit 275 may output an audio file stored in the storage 280 under the control of the processor 210.

The audio output unit 275 may include at least one of a speaker 276, a headphone output terminal 277, and an S/PDIF output terminal 278 or a combination of the speaker 276, the headphone output terminal 277, and the S/PDIF output terminal 278.

The audio output unit 275 according to an embodiment may output an auditory feedback in response to the display of a recommendation guide under the control of the processor 210.

The storage 280 may store various data, programs, or applications for driving and controlling the display apparatus 200 under the control of the processor 210. The storage 280 may store signals or data which is input/output in response to the driving of the tuner 220, the communicator 230, the microphone 240, the camera 245, the optical receiver 250, the input/output unit 260, the display 270, the audio output unit 275, and the power supply 290.

The storage 280 may store the control program to control the display apparatus 200 and the processor 210, the applications initially provided by a manufacturer or downloaded externally, a graphical user interface (“GUI”) that relates to the applications, objects to be included in the GUI (e.g., images, texts, icons and buttons), user information, documents, voice database, motion database, and relevant data.

In addition, the storage 280 may include any of a broadcast reception module, a channel control module, a volume control module, a communication control module, a voice identification module, a motion identification module, an optical reception module, a display control module, an audio control module, an external input control module, a power control module, a voice database and a motion database.

Modules and databases which are not illustrated in the storage may be implemented in a software format in order to perform the control functions of broadcast receiving, the channel control function, the volume control function, the communication control function, the voice recognition function, the motion recognition function, the optical receiving function, the display control function, the audio control function, the external input control function, and/or the power control function. The processor 210 may perform the operations and/or functions of the display apparatus 200 by using the software stored in the storage 280.

The storage 280 may store voice data received from the voice recognition server 300. The storage 280 may store control information received from the remote controller 300. The storage 280 may store control information received from an interactive server (not illustrated).

The storage 280 may store a database that corresponds to a phoneme that corresponds to a user voice. In addition, the storage 280 may store a control information database that corresponds to voice data.

The storage 280 may store a video, images or texts that correspond to a visual feedback.

The storage 280 may store sounds that correspond to an auditory feedback.

The storage 280 may store a feedback providing time (e.g., 300 ms) of a feedback provided to a user.

The term “storage” as used in the embodiments may include the storage 280, the ROM 212 of the processor 210, the RAM 213, a storage (not shown) which is implemented by using a SoC (not shown), a memory card (not shown) (e.g., a micro secure digital (SD) card or a USB memory) which is mounted in the display apparatus 200, and an external storage (not shown) connectable to the port of the USB 264 of the input/output unit 260 (e.g., a USB memory). In addition, the storage may include a non-volatile memory, a volatile memory, a hard disk drive (HDD), or a solid state drive (SSD).

The power supply 290 supplies power received from external power sources to the internal elements 210-290 of the display apparatus 200 under the control of the processor 210. The power supply 290 may provide power received from one battery, two batteries, or more than two batteries positioned within the display apparatus 200 to the internal elements 210-290 under the control of the processor 210.

The power supply 290 may include a battery (not shown) that is configured to supply power to the camera 245 of the display apparatus 200 which is turned off (although a power plug may be connected to a power outlet).

From among the elements 210-290 of the display apparatus 200 illustrated in FIGS. 1 and 2, at least one element (e.g., at least one of the elements illustrated by dashed boxes) may be added, changed, or deleted based on the performance and/or type of the display apparatus 200. In addition, it shall be easily understood by a person having ordinary skill in the art that the locations of the elements 210-290 may be changed based on the performance or configuration of the display apparatus 200.

Hereinafter, a method for controlling the screen of the display apparatus will be described in greater detail.

Referring to FIG. 2, the remote controller 100 which remotely controls the display apparatus 200 may include a controller 110, a communicator 130, an optical output unit 150, a display 170, a storage (also referred to as a “memory”) 180, and a power supply 190. The remote controller 100 may include one of the communicator 130 and the optical output unit 150. Alternatively, the remote controller 100 may include both of the communicator 130 and the optical output unit 150.

The remote controller may refer to an electronic apparatus that is capable of controlling a display apparatus remotely. In addition, the remote controller 100 may include an electronic apparatus that is capable of installing (or downloading) an application (not shown) to control the display apparatus 200.

An electronic apparatus that is capable of controlling an application (not shown) to control the display apparatus 200 may include a display (e.g., a display having only a display panel without a touch screen or a touch panel). For example, the electronic apparatus having a display may include a mobile phone (not shown), a smart phone (not shown), a tablet PC (not shown), a notebook PC (not shown), other display apparatuses (not shown), or a home appliance (e.g., a refrigerator, a washing machine, or a cleaner), or the like, but is not limited thereto.

A user may control the display apparatus 200 by using a button (not shown) (for example, a channel change button) on a GUI (not shown) provided by the executed application.

The controller 110 may include a processor 111, ROM 112 (or non-volatile memory) that stores a control program for the controlling of the remote controller 100, and RAM 113 (or volatile memory) that stores signals or data that is inputted outside the remote controller 100 and that is used as storing area regarding the various operations performed in the remote controller 100.

The controller 110 may control general operations of the remote controller 100 and signal flows between the internal elements 110-190, and process data. The controller 110 controls the power supply 190 to supply power to the internal elements 110-190.

According to an embodiment, the controller 110 may include the processor 111, the ROM 112 and the RAM 113 of the remote controller 100.

The communicator 130 may transmit a control signal (e.g., a control signal that corresponds to power on or a control signal that corresponds to a volume adjustment) in correspondence with a user input (e.g., a touch, pressing, a touch gesture, a voice, or a motion) to the display apparatus 200 under the control of the processor 110.

The communicator 130 may be wirelessly connected to the display apparatus 200. The communicator 130 may include at least one of a wireless LAN communicator 131 and a near field communicator 132 or both of the wireless LAN communicator 131 and the near field communicator 132.

The communicator 130 of the remote controller 100 is substantially similar to the communicator 230 of the display apparatus 200, and thus redundant descriptions will be omitted.

The input unit 160 may include a button 161 and/or a touch pad 162 which receives a user input (e.g., touching or pressing) in order to control the display apparatus 200. The input unit 160 may include a microphone 163 for receiving an uttered user voice, a sensor 164 for detecting a movement of the remote controller 100, and a vibration motor (not shown) for providing a haptic feedback.

The input unit 160 may transmit an electrical signal (e.g., an analog signal or a digital signal) that corresponds to the received user input (e.g., touching, pressing, touch gestures, a voice or a motion) to the controller 110.

The button 161 may include buttons 161a to 161h of FIG. 1. The touch pad 162 may receive a user's touch or a user's touch gesture. The touch pad 162 may be implemented as a direction key or an enter key. Further, the touch pad 162 may be positioned on a front section of the remote controller 100.

The microphone 163 receives a voice uttered by the user. The microphone 163 may convert the received voice and output the converted voice to the controller 110. The controller 110 may generate a control signal (or an electrical signal) that corresponds to the user voice and transmit the control signal to the display apparatus 200.

The sensor 164 may detect an internal state and/or an external state of the remote controller 100. For example, the sensor 164 may include any of a motion sensor (not shown), a gyro sensor (not shown), an acceleration sensor (not shown), and/or a gravity sensor (not shown). The sensor 164 may measure the movement acceleration or the gravity acceleration of the remote controller 100, respectively.

The vibration motor (not shown) may convert a signal into a mechanical vibration under the control of the controller 210. For example, the vibration motor may include any of a linear vibration motor, a bar type vibration motor, a coin type vibration motor, and/or a piezoelectric element vibration motor. A single vibration motor (not shown) or a plurality of vibration motors (not shown) may be disposed inside the remote controller 200.

The optical output unit 150 outputs an optical signal (e.g., including a control signal) that corresponds to a user input (e.g., a touch, pressing, a touch gesture, a voice, or motion) under the control of the controller 110. The output optical signal may be received at the optical receiver 250 of the display apparatus 200. For the remote controller code format used in the remote controller 100, one of the manufacturer exclusive remote controller code format and the commercial remote controller code format may be used. The remote control code format may include a leader code and a data word. The output optical signal may be modulated by a carrier wave and then outputted. The control signal may be stored in the storage 180 or generated by the controller 110. The remote controller 100 may include an Infrared-laser emitting diode (IR-LED).

The remote controller 100 may include one or both of the communicator 130 and the optical output unit 150 that may transmit a control signal to the display apparatus 200.

The controller 110 may output a control signal that corresponds to a user input to the display apparatus 200. The controller 110 may transmit a control signal that corresponds to a user input to the display apparatus 200 with the priority via one of the communicator 130 and the optical output unit 150.

The display 170 may display a broadcast channel number, a broadcast channel name, and/or a state of the display apparatus (e.g., screen off, a pre-power on mode, and/or a normal mode) which is displayed on the display apparatus 200.

If an optical signal is output from the remote controller 100 to the display apparatus 200, the display 170 may display a text, an icon, or a symbol that corresponds to “TV ON” for turning on the power of the display apparatus 200, “TV OFF” for turning off the power of the display apparatus 200, “Ch. No.” for displaying a tuned channel number, or “Vol. Value” for indicating an adjusted volume under the control of the controller 110.

For example, the display 170 may include a display of a Liquid Crystal Display (LCD) method, an Organic Light Emitting Diodes (OLED) method or a Vacuum Fluorescent Display (VFD) method.

The storage 180 may store various data, programs or applications which are configured to drive and control the remote controller 100 under the control of the controller 110. The storage 180 may store signals or data which are input or output according to the driving of the communicator 130, the optical output unit 150, and the power supply 190.

The storage 180 may store control information that corresponds to a received user input (e.g., a touch, pressing, a touch gesture, a voice, or a motion) and/or control information that corresponds to a movement of the remote controller 100 under the control of the controller 110.

The storage 180 may further store the remote controller information that corresponds to the remote controller 100. The remote control device information may include any of a model name, an original device ID, remaining memory, whether to store object data, Bluetooth version and/or Bluetooth profile.

The power supply 190 supplies power to the elements 110 to 190 of the remote controller 100 under control of the controller 110. The power supply 190 may supply power to the elements 110 to 190 from one or more batteries positioned in the remote controller 100. The battery may be disposed inside the remote controller 200 between the front surface (e.g., a surface on which the button 161 or the touch pad 162 is formed) and the rear surface (not shown) of the remote controller 200.

From among the elements of the remote controller 100 illustrated in FIGS. 1 and 2, at least one element (e.g., at least one of the elements illustrated by dashed boxes) may be added or deleted based on the performance of the remote controller 100. In addition, it shall be easily understood by a person having ordinary skill in the art that the locations (i.e., positioning) of the elements may be changed based on the performance or configuration of the remote controller 100.

The voice recognition server 300 receives a packet that corresponds to a user voice input at the remote controller 100 or the display apparatus 200 via a communicator (not shown). The processor (not shown) of the voice recognition server 300 performs voice recognition by analyzing the received packet using a voice recognition unit (not shown) and a voice recognition algorithm.

The processor of the voice recognition server 300 may convert a received electrical signal (or a packet that corresponds to the electrical signal) into voice recognition data that includes a text in the form of word or sentence by using the voice recognition algorithm.

The processor of the voice recognition server 300 may transit the voice data to the display apparatus 200 via the communicator of the voice recognition server 300.

The processor of the voice recognition server 300 may convert the voice data to control information (e.g., a control command). The control information may control the operations (or functions) of the display apparatus 200.

The voice recognition server 300 may include a control information database. The processor of the voice recognition server 300 may determine control information that corresponds to the converted voice data by using the control information database which is stored.

The voice recognition server 300 may convert the converted voice data to control information (e.g., control information parsed by the controller 210 of the display apparatus 200) for controlling the display apparatus 200 by using the control information database.

The processor of the voice recognition server 300 may transmit the control information to the display apparatus 200 via the communicator of the voice recognition server 300.

According to an embodiment, the voice recognition server 300 may be formed integrally with the display apparatus 200 (i.e., as indicated by reference number 200′). The voice recognition server 300 may be included (200′) in the display apparatus 200 as a separate element from the elements 210-290 of the display apparatus 200. The voice recognition server 300 may be embedded in the storage 280 of the display apparatus 200 or may be implemented in a separate storage (not shown).

According to an embodiment, an interactive server (not shown) may be implemented separately from the voice recognition server 300. The interactive server may convert voice data received from one of the voice recognition server 300 and the display apparatus 200 into control information. The interactive server may transmit the converted control information to the display apparatus 200.

At least one element illustrated in the voice recognition server 300 of FIGS. 1 and 2 may be modified, added or deleted according to the performance of the voice recognition server 300.

Although the configurations of remote controller 100 and the display apparatus 100 have been illustrated and described in detail in FIG. 2 in order to explain various embodiments, the screen displaying method according to the embodiments is not limited thereto.

For example, the display apparatus 200 may be configured to include a display configured for displaying various contents, a communicator configured for communicating with a remote controller and a voice recognition server, and a processor configured for controlling the same. If a signal that corresponds to a user voice is received via a communicator and a voice recognition result regarding the user voice is obtained from the voice recognition server, the processor may display any of various recommendation guides. According to an embodiment in which a recommendation guide is determined based on history information, the display apparatus 200 may further include a storage configured for storing history information that corresponds to a voice utterance history for each user. The type of recommendation guide and the displaying methods thereof will be described below in detail.

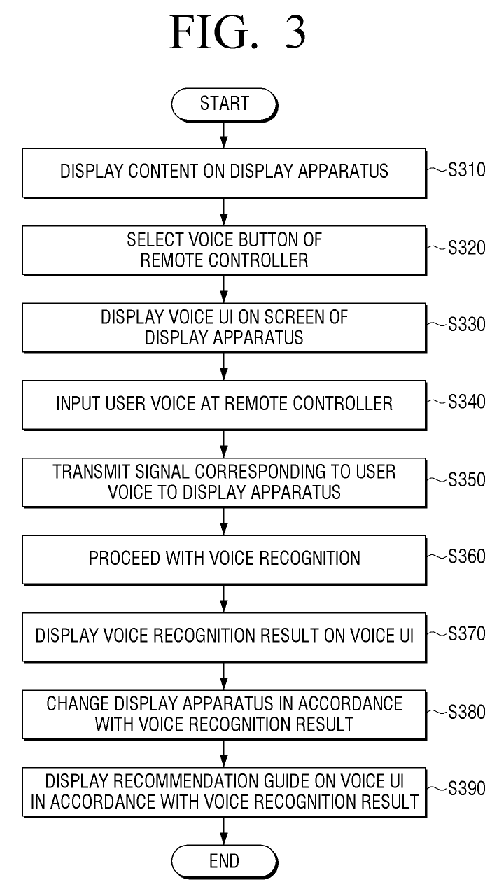

FIG. 3 is a schematic flowchart illustrating a method for displaying a screen of a display apparatus, according to an embodiment.

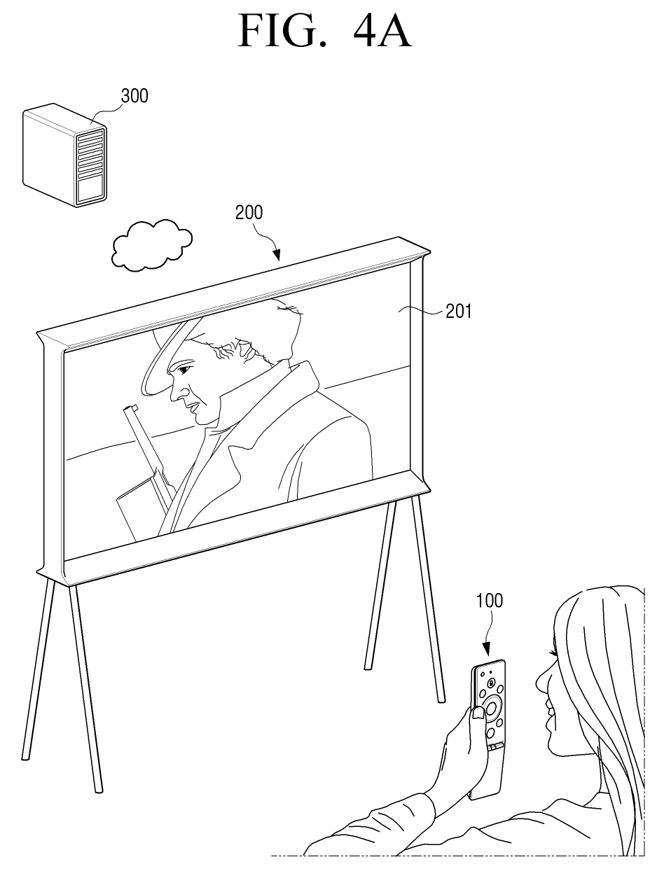

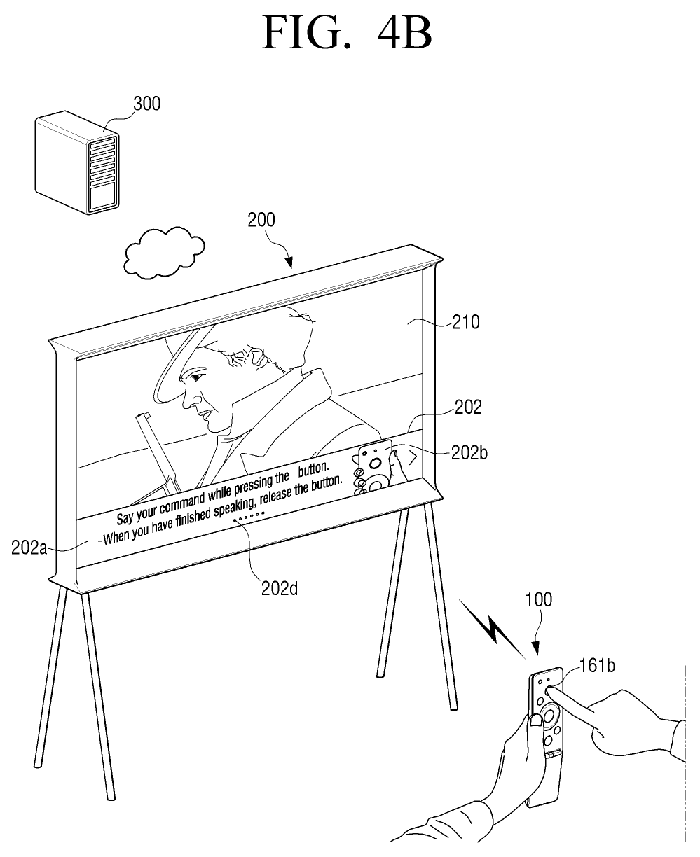

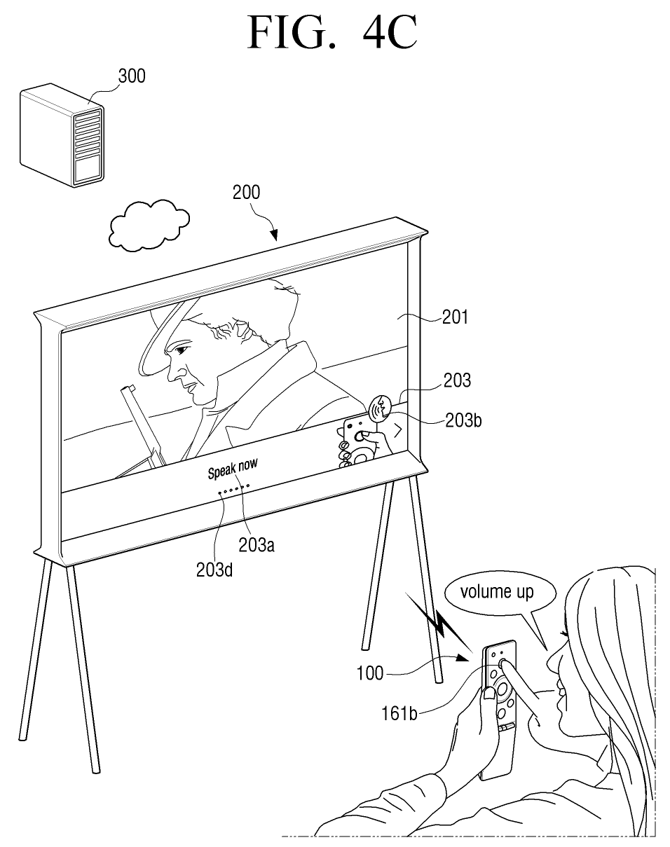

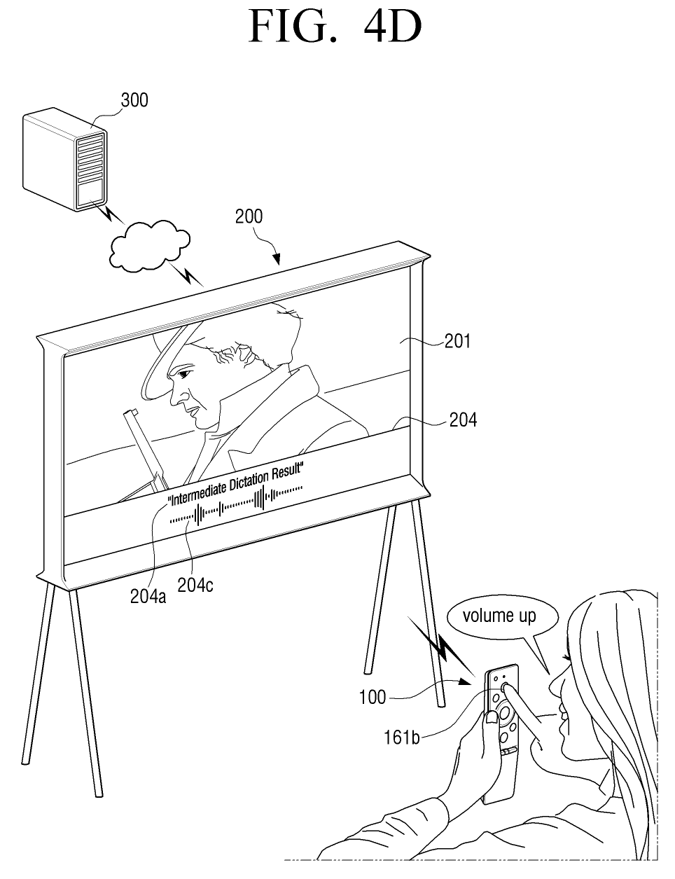

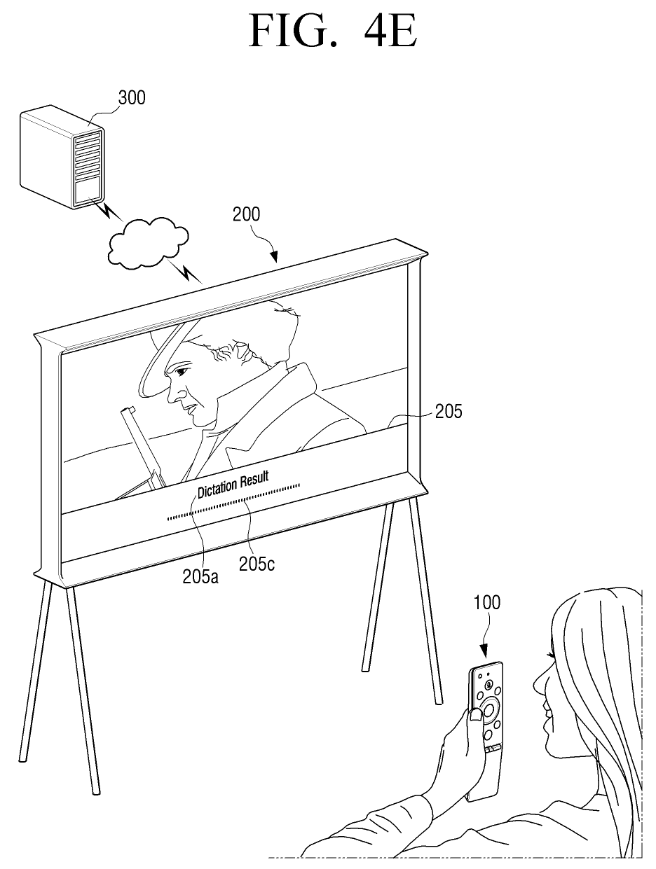

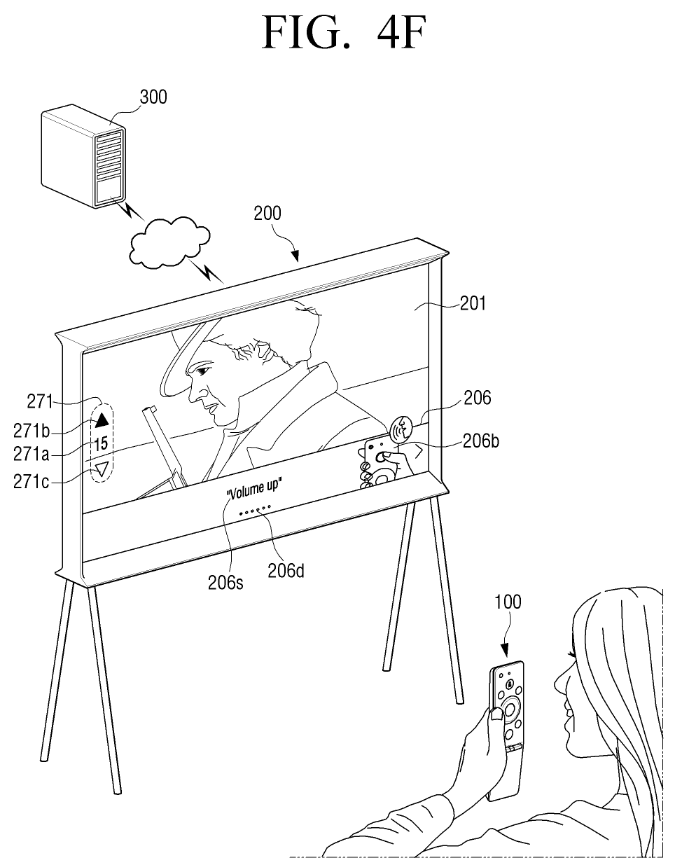

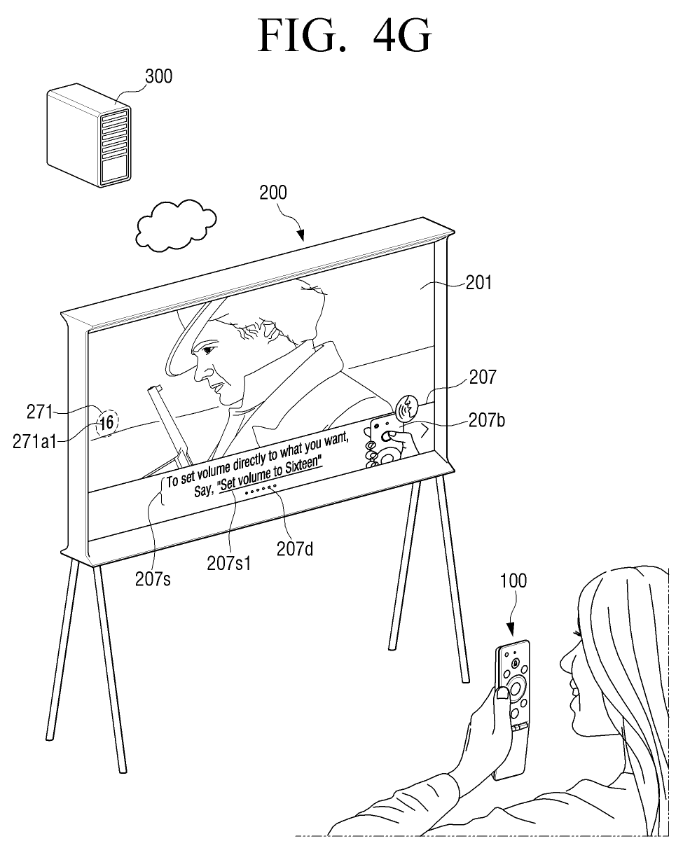

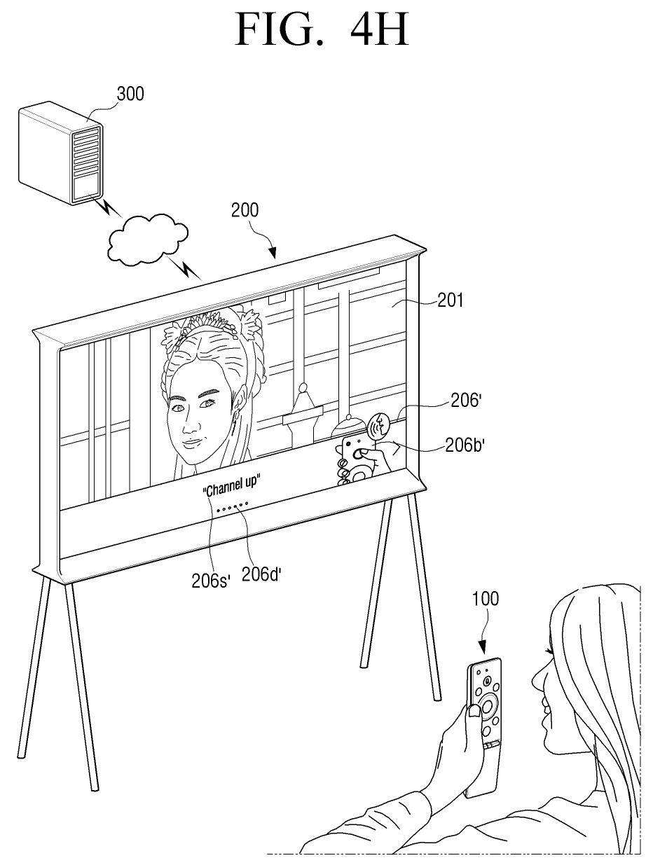

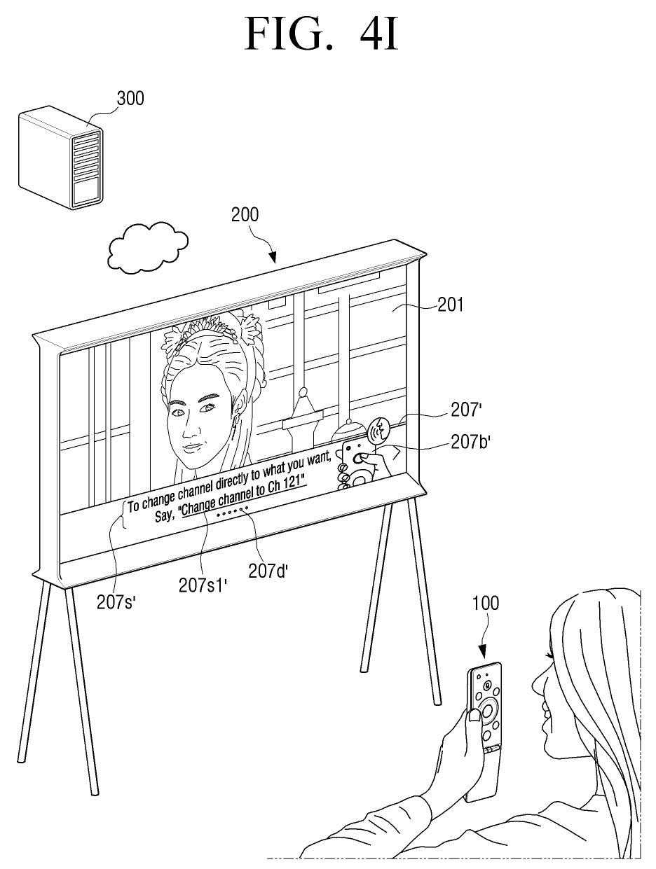

FIGS. 4A, 4B, 4C, 4D, 4E, 4F, 4G, 4H, and 4I are schematic views illustrating examples of a method for displaying a screen of a display apparatus, according to an embodiment.

In step S310 of FIG. 3, a content is displayed on a display apparatus.

Referring to FIG. 4A, a content 201 (e.g., a broadcasting signal or a video, etc.) is displayed on the display apparatus 200. The display apparatus 200 is connected to the remote controller 100 wirelessly (e.g., via the wireless LAN communicator 232 or the near field communicator 233).

The display 200 to which power is supplied displays the content 201 (for example, a broadcast channel or a video). In addition, the display apparatus 200 may be connected to the voice recognition server 300 in a wired or wireless manner.

Based on the remote controller 200 and the display apparatus 100 beinginitially connected to each other, the controller 110 of the remote controller 100 may search the display apparatus 200 by using the near field communicator 132 (e.g., Bluetooth or Bluetooth low energy). The processor 111 of the remote controller 100 may transmit an inquiry to the display apparatus 200 and make a connection request to the inquired display apparatus 200.

In step S320 of FIG. 3, a voice button of the remote controller is selected.

Referring to FIG. 4B, a user selects a voice button 161b of the remote controller 100. The processor 111 may control such that the microphone 163 operates in accordance with the user selection of the voice button 161b. In addition, the processor 111 may control such that power is supplied to the microphone 163 in accordance with the user selection of the voice button 161b.

The processor 111 may transmit a signal that corresponds to the start of the operation of the microphone 163 to the display apparatus 200 via the communicator 130.

In step of S330 of FIG. 3, a voice user interface (UI) is displayed on the screen of the display apparatus.

Referring to FIG. 4B, the voice UI 202 is displayed on the screen of the display apparatus 200 in response to the operation of the microphone 163 under the control of the controller 210. The shorter the interval between the display time of the voice UI 202 in the display apparatus 200 in correspondence with the selection of the voice button 161b in the remote control apparatus 100 is, the better the user experience is provided to the user. The voice UI 202 may be displayed in the remote control apparatus 100 at a time of 500 ms (variable) or less based on the selection time point of the voice button 161b.

The display time of the voice UI 202 may vary based on a performance of the display apparatus 200 and/or a communication state between the remote control apparatus 100 and the display apparatus 200.

The voice UI 202 refers to a guide user interface provided to the user that corresponds to a user's utterance. For example, when the user utters, the processor 211 of the display apparatus 200 may provide the user with a user interface for a voice guide composed of a text, an image, a video, or a symbol that corresponds to the user utterance. The voice UI 202 can be displayed separately from the content 201 displayed on the screen.

In addition, the voice UI 202 may include a user guide (e.g., the text 202a, the image 202b, a video (not shown), and/or a symbol 202d, etc.) displayed on one side of the display apparatus 200. The user guide may display one or combination of a text, an image, a video, and a symbol.

The voice UI 202 may be located on one side of the screen of the display apparatus 200. In addition, the voice UI 202 may be superimposed on the content 201 displayed on the screen of the display apparatus 200. The voice UI 202 may have transparency that has a degree (e.g., 0% to 100%). The content 201 may be displayed in a blurred state based on the transparency of the voice UI 202. In addition, in the exemplary embodiment of the present disclosure, the voice UI can be displayed separately from the content 201 on the screen.

Referring to FIG. 4C, if the set time (e.g., 100 ms, variable) has elapsed, the processor 211 of the display apparatus 200 may display another voice UI 203. The area of the voice UI 202 may be different from the area of another voice UI 203 (e.g., as illustrated by image 203b). The voice UI 203 may include a user guide (e.g., text 203a, image 203b, and symbol 203d, etc.) that is displayed on one side of the screen of the display apparatus 200.

The processor 211 of the display apparatus 200 may transmit a signal (e.g., a signal that corresponds to preparation for an operation of the voice recognition unit (not shown) of the voice recognition server 300) that corresponds to selection of the voice button 161b in the remote control apparatus 100 to the voice recognition server 300 via the communicator 230.

In step S340 of FIG. 3, a user voice is input in the remote control apparatus.

Referring to FIG. 4C, the user utters (e.g., “volume up”) for control of the display apparatus 200. The microphone 163 of the remote control apparatus 100 may receive (or input) the voice of the user. The microphone 163 may convert the received signal into a signal that corresponds to the received user voice (e.g., a digital signal or an analog signal) and output the signal to the processor 111.

The processor 111 may store a signal that corresponds to the received user voice in a storage 180.

In another exemplary embodiment, the user voice may be input via the microphone 240 of the display apparatus 200. For example, the user may not select the voice button 161b of the remote control apparatus 100, but instead directly utter, for example, “volume up”, toward the front surface of the display apparatus 200 (e.g., the display portion 270 is exposed). Even when a user voice is input directly to the display apparatus 200, the operation of the display apparatus 200 and the voice recognition server 300 is substantially similar to the voice input via the remote control apparatus 100 (e.g., a difference of path of voice input).

In step S350 of FIG. 3, a signal that corresponds to a user voice is transmitted to a display apparatus.

Referring to FIG. 4D, the processor 111 of the remote control apparatus 100 may transmit a signal that corresponds to the stored user voice to the display apparatus 200 via the communicator 130. When a part of the signal that corresponds to the user voice is stored in the storage 180, the processor 110 of the remote control apparatus 100 may directly transmit (or delayed by 100 ms or less (variable)) a part of the signal that corresponds to the user voice via the communicator 130 to the display apparatus 200.

The processor 111 of the remote control apparatus 100 may transmit (or convert and transmit) a signal that corresponds to the stored user voice based on a wireless communication standard so that the display apparatus 200 may receive the signal. The processor 111 of the remote control apparatus 100 may control the communicator 130 to transmit a packet that includes a signal that corresponds to the stored user voice. The packet may be a packet that conforms to the specification of local area communication.

When a packet is received from the remote control apparatus 100, the processor 211 of the display apparatus 100 may store the received packet in the storage 280.

The processor 211 of the display apparatus 200 may analyze (or parse) the received packet. According to the analysis result, the processor 211 of the display apparatus 200 may determine that a signal that corresponds to the user voice has been received.

The processor 211 of the display apparatus 200 displays another voice UI 204 that corresponds to a reception of a packet. The voice UI 204 may include a text 204a and a video 204c that corresponds to a reception of a packet.

The voice UI 204 is substantially the same qualitatively (e.g., difference of text, difference of image and video, etc.) with the voice UI 202 and thus, a redundant description thereof shall be omitted.

The processor 211 of the display apparatus 200 may transmit the received packet to the voice recognition server 300 via the communicator 230. The processor 211 of the display apparatus 200 may convert the received packet as it is, or the received packet may be transmitted to the voice recognition server 300.

In step S360 of FIG. 3, voice recognition is performed.

The voice recognition server 300 performs voice recognition by using the voice recognition algorithm for the received packet. The voice recognition algorithm divides a packet into sections having a predetermined length, and analyzes each section to extract parameters that include a frequency spectrum and voice power. The voice recognition algorithm may divide the packet into phonemes and recognize phonemes based on the parameters of the divided phonemes.

The storage (not shown) of the voice recognition server 300 may store (update) a phonemic database that corresponds to a specific phoneme. The processor (not shown) of the voice recognition server 300 may generate voice data by using the recognized phonemes and a pre-stored database.

The processor (not shown) of the voice recognition server 300 may generate voice recognition data in a form of a word or a sentence. The aforementioned voice recognition algorithm may include, for example, a hidden Markov model and/or any other suitable voice recognition algorithm.

The processor of the voice recognition server 300 may recognize a waveform of the received packet as a voice and generate voice data.

The processor of the voice recognition server 300 may store the generated voice data in a storage (not shown). The processor of the voice recognition server 300 may transmit voice data to the display apparatus 200 via a communicator (not shown) before transmitting the control information.

The processor of the voice recognition server 300 may conduct conversion to control information (e.g., control command) by using voice data. The control information may control an operation (or a function) of the display apparatus 200.

The voice recognition server 300 may include a control information database. The processor of the voice recognition server 300 may determine control information that corresponds to the converted voice data by using the control information database stored in the processor.

The voice recognition server 300 may convert the converted voice data to control information (e.g., parsed by the processor 211 of the display apparatus 200) in order to control the display apparatus 200 by using the control information database.

For example, based on a user's voice (for example, an analog waveform that corresponds to “volume up”) being received, the display apparatus 200 may transmit an electrical signal that corresponds to the voice (e.g., a digital signal, an analog signal, or a packet) to the voice recognition server 300. The voice recognition server 300 may convert the received electrical signal (or packet) to voice data (e.g., “volume up”) via voice recognition. The voice recognition server 300 may convert (or generate) control information by using voice data.

Based onthe display apparatus 200 receiving control information, the processor 211 of the display apparatus 200 may increase a volume by using control information that corresponds to voice data.

The processor of the voice recognition server 300 may transmit control information to the display apparatus 200 via the communicator.

Referring to FIG. 4E, when voice recognition is performed in the voice recognition server 300, the voice UI 205 is displayed on the screen of the display apparatus 200. The voice UI 205 may include text 205a and video 205c that corresponds to voice recognition of the voice recognition server 300. The video 205c that corresponds to voice recognition may be an image or a symbol.

In step S370 of FIG. 3, the voice recognition result is displayed on the voice UI.

Referring to FIG. 4F, the processor 210 of the display apparatus 200 may receive voice data from the voice recognition server 300 via the communicator 230. In addition, the processor 211 of the display apparatus 200 may receive control information from the voice recognition server 300 via the communicator 230.

The processor 211 of the display apparatus 200 may display the voice UI 206 based on the reception of the voice data. The processor 211 of the display apparatus 200 may display the received voice data 206s on the voice UI 206. The voice UI 206 may include text 206s, image 206b and symbol 206d in correspondence with the reception of voice data. The area of the voice UI 206 may be different from the area of one of the previously displayed voice UIs 201 to 205.

The processor 211 may display the received voice data 206s on the voice UI 206. The voice UI 206 may include text 206s, image 206b and symbol 206d in correspondence with the reception of voice data. The area of the voice UI 206 may be different from the area of one of the previously displayed voice UIs 201 to 205.

The processor 211 of the display apparatus 200 may display a time guide 271 on one side of the screen based on a reception of the control information. The time information displayed on one side of the screen of the display apparatus 200 includes the volume value (e.g., “15”, 271a) of the current display apparatus 200 and the volume keys 271b and 271c which respectively correspond to increase/decrease of volume.

In the visual guide 271, the volume keys 271b, 271c can be displayed distinctively according to increase or decrease in volume. For example, in case of increase in volume, the visual guide 271 as shown in FIG. 4F can be displayed.

The voice UI 206 and the visual guide 271 may be displayed in priority order. For example, after the voice UI 206 is displayed, the processor 211 may display the visual guide 271. Further, the processor 211 may display the voice UI 206 and the visual guide 271 together.

Referring to FIG. 4H, a voice UI according to another exemplary embodiment (e.g., voice data is “channel up”) is displayed.

The steps S310 to S360 of FIG. 3 when the voice data corresponds to a channel increase are substantially similar to the steps S310 to S360 of FIG. 3 when voice data is increased in volume (e.g., voice data difference) and thus, duplicate descriptions will be omitted.

Referring to FIG. 4H, the processor 211 of the display apparatus 200 may receive voice data (e.g., “channel up”) from the voice recognition server 300 via the communicator 230. In addition, the processor 211 of the display apparatus 200 may receive the control information that corresponds to the “channel up” from the voice recognition server 300 via the communicator 230.

The processor 211 of the display apparatus 200 may display the voice UI 206′ based on the reception of the voice data. The processor 211 of the display apparatus 200 may display the received voice data 206s′ on the voice UI 206′. The voice UI 206′ may include a text that corresponds to the reception of voice data (e.g., “channel up”, 206s′), an image 206b′ and a symbol 206d′.

The voice UI 206′ that corresponds to the voice data (e.g., “channel up”) is substantially the same as voice data (e.g., “volume up”) and thus, a duplicate description shall be omitted.

The processor 211 of the display apparatus 200 may display a visual guide (not shown) on one side of the screen based on reception of the control information. The visual information displayed on one side of the screen of the display apparatus 200 may include at least one of a current channel number (e.g., “120”, not shown) of the current display apparatus 200 and a channel key (not shown) that corresponds to the increase/decrease.

In step S380 of FIG. 3, a display apparatus changes based on a voice recognition result.

Referring to FIG. 4G, the display apparatus (or setting of the display apparatus, 200) is changed based on the voice recognition result. The processor 211 of the display apparatus 200 may change the set current volume (e.g., change the output of the speaker 276 from “15” to “16”) based on the voice recognition result. The item of the display apparatus 200 that is changed in response to the voice recognition result may be an item of the display apparatus 200 that may be changed via the remote control apparatus 100.

Based on the voice recognition result, the processor 211 may display the visual guide 271a1 in correspondence with the change of the set current volume (e.g., “15” to “16”). The processor 211 may control to display the visual guide 271a after controlling the output of the speaker 276 to change from “15” to “16”.

Referring to FIG. 4I, the display apparatus (or the setting of the display apparatus, 200) is changed in correspondence with the voice recognition result according to another embodiment. Based on the voice recognition result, the processor 211 of the display apparatus 200 may change the current channel number displayed on the screen (e.g., channel number changes from 120 to 121).

The above-described volume change is an exemplary embodiment, and is not limited thereto. For example, that the present embodiment may be applied to a power on/off operation of the display apparatus 200 which is executable via voice recognition, any of channel change, smart hub execution, game execution, application execution, web browser execution, and/or content execution may be easily understood by persons having ordinary skill in the art.

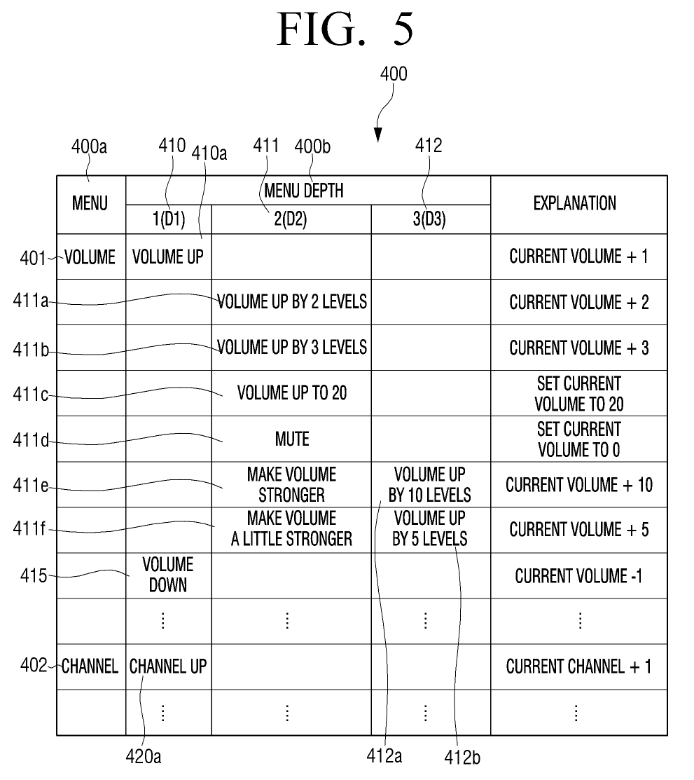

FIG. 5 is a schematic drawing illustrating an example of a recommended voice data list that corresponds to voice data, according to an exemplary embodiment.

In step S390 of FIG. 3, a recommendation guide is displayed on the voice UI based on the voice recognition result.

Referring to FIG. 4G, the processor 210 of the display apparatus 200 may display a recommendation guide 207s on the screen based on the voice recognition result. The processor 211 of the display apparatus 200 may display the recommendation guide 207s in the voice UI 207 based on the voice recognition result.

The recommendation guide 207s may include recommended voice data 207s1 that corresponds to a user's utterable voice (e.g., volume up, etc.). If the user selects the recommended voice data (e.g., “set volume to sixteen” 207s1) based on the display of the recommendation guide (e.g., “to set volume directly to what you want, Say, ‘set volume to sixteen’, 207s), an operation or function of the display apparatus 200 may be changed based on voice recognition.

When the user utters a part of the recommended voice data 207s1 that is included in the recommendation guide 207s, the operation or the function of the display apparatus 200 may be changed based on voice recognition. In the embodiment, the recommendation guide 207s may have the same meaning as the recommended voice data 207s1.

The operation (e.g., volume, channel, search, etc.) of the display apparatus 200 may be changed by the recommendation guide 207s and voice data (e.g., “volume up”). The volume of the display apparatus 200 may be changed by a recommendation guide (e.g., “set volume to sixteen”, 207s) and voice data (e.g., “volume up”). The processor 211 of the display apparatus 200 may change the current volume based on the recognized voice data or the recommended guide.

Referring to FIG. 5, an example of a list 400 of voice data and recommended voice data is displayed. A part of the voice data and the recommended voice data list 400 that corresponds to the volume change (i.e., volume 401) is displayed in the menu 400a during the setting of the display apparatus 200. The voice data and the recommended voice data list described above may be stored in the storage 280 or may be stored in a storage (not shown) of the voice recognition server 300.

In order to change the volume of the display apparatus 200, the user inputs menu depth 1 (depth 1, 410) voice data, depth 2 411 (i.e., voice data 411a, 411b, 411c, 411d, 411e, 4110, or depth 3 412 (i.e., voice data 412a, 412b) in the menu depth section 400b. The above-described depth 1 voice data to depth 3 voice data exemplify one embodiment, and the depth 4 voice data (not shown), the depth 5 voice data (not shown), or the depth 6 voice data (or more) may be included.

The above-described list 400 of the voice data and recommended voice data is applicable to a menu for controlling the display apparatus 200.

The processor 211 of the display apparatus 200 may output the voice data of the user 1 (e.g., the volume of the voice data 410a). For example, when the user utters depth 1 voice data (e.g., volume up, 410a) for volume change of the display apparatus 200, the processor 211 of the display apparatus 200 may store and update the voice data utterance history (e.g., depth 1 voice data utterance history, depth 2 voice data utterance history, or depth 3 voice data utterance history). The processor 211 may store information on voice data utterance history (or “history information”) that corresponds to voice data utterance history of a user in the storage 280. Voice data utterance history information which corresponds to a user may be stored respectively. In addition, the processor 211 may transmit history information to the voice recognition server 300. The voice recognition server 300 may store the received history information to the storage of the voice recognition server 300.

The processor 211 may determine the user's frequently used voice data (e.g., the number of utterances is more than 10, variable) by using the voice data utterance history of the user. For example, when the user frequently uses the depth 1 voice data 410a to change the volume of the display apparatus 200, the processor 211 of the display apparatus 200 may display one of the depth 2 voice data 411a to 411f and the depth 3 voice data 412a and 412b as the recommendation voice data 207d.

When the user frequently uses the depth 1 voice data 410a and the depth 2 voice data 411b to change the volume of the display apparatus 200, the processor 211 of the display apparatus 200 may display, on the voice UI 207, one of the depth 2 voice data 411a, 411c to 411f, and depth 3 voice data 412a, 412b as the recommended voice data 207d.

The processor 211 may provide different recommendation guides to different users by using respective voice data utterance history information.

The processor 211 may store user-specific voice data utterance history information in the storage 280 in conjunction with user authentication. For example, the storage 280 may store the first user-specific voice data utterance history information, the second user-specific voice data utterance history information, or the third user-specific voice data utterance history information under the control of the processor 211.

The processor 211 may provide (or display) another recommendation guide that corresponds to the user voice data utterance history information based on the authenticated user. For example, when receiving the same voice recognition result, the processor 211 may provide different recommendation guides for each user by using the respective user-specific voice data utterance history information.

The voice UI 207 may include a text 207s1 that corresponds to the provision of the recommendation guide. Further, the voice UI 207 may further include an image 207b and/or a symbol 207 that corresponds to the provision of the recommendation guide. The area of the voice UI 207 may be different from the area of one of the previously displayed voice UIs 201 to 206.

The user may check the recommended voice data 207d which is displayed. In addition, the user may utter based on the displayed recommended voice data 207d.

Referring to FIG. 4I, a change and recommendation guide of the display apparatus according to another exemplary embodiment (e.g., voice data is “channel up”) is displayed.

Referring to FIG. 4I, the processor 211 of the display apparatus 200 may display the recommendation guide 207s′ based on the voice recognition result on a screen. The processor 211 of the display apparatus 200 may display the recommendation guide 207s′ based on the voice recognition result on the voice UI 207′.

The recommendation guide 207s′ may include recommended voice data 207s1′ that corresponds to a user's utterable voice (e.g., channel up, etc.). If the user utters the recommended voice data (e.g., “Change channel to Ch 121”, 207s1′) from the recommendation guide (e.g., “to change channel directly to what you want, say ‘Change channel to Ch 121’”, 207s′), the operation or function of the display apparatus 200 may be changed based on voice recognition.

When the user utters a part of the recommended voice data 207s1′ in the recommendation guide 207s′, the operation or function of the display apparatus 200 may be changed based on voice recognition. In the exemplary embodiment, the recommendation guide 207s′ may have the same meaning as the recommended voice data 207s1′.

A list of voice data and recommended voice data that corresponds to another exemplary embodiment (e.g., channel change 402 and “channel up”, 420a, referring to FIG. 5) of the present disclosure is substantially the same as a list of voice data and recommended voice data of an exemplary embodiment (e.g., “volume up”) and thus, a duplicate description will be omitted.

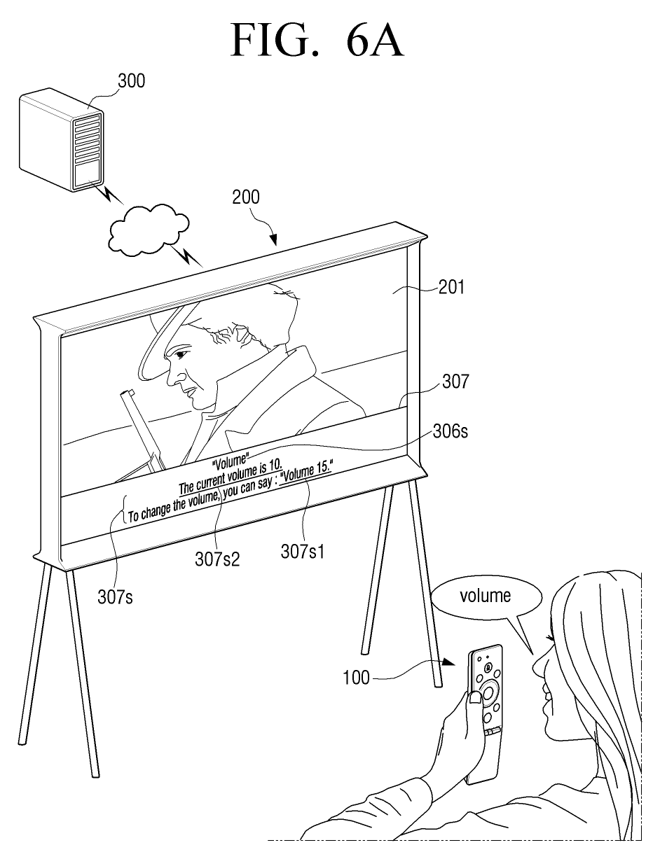

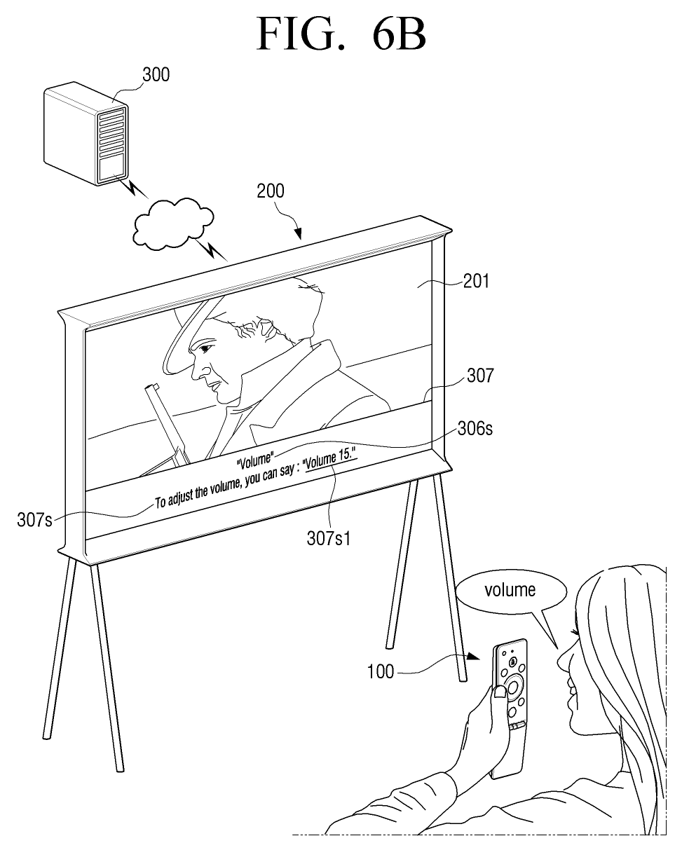

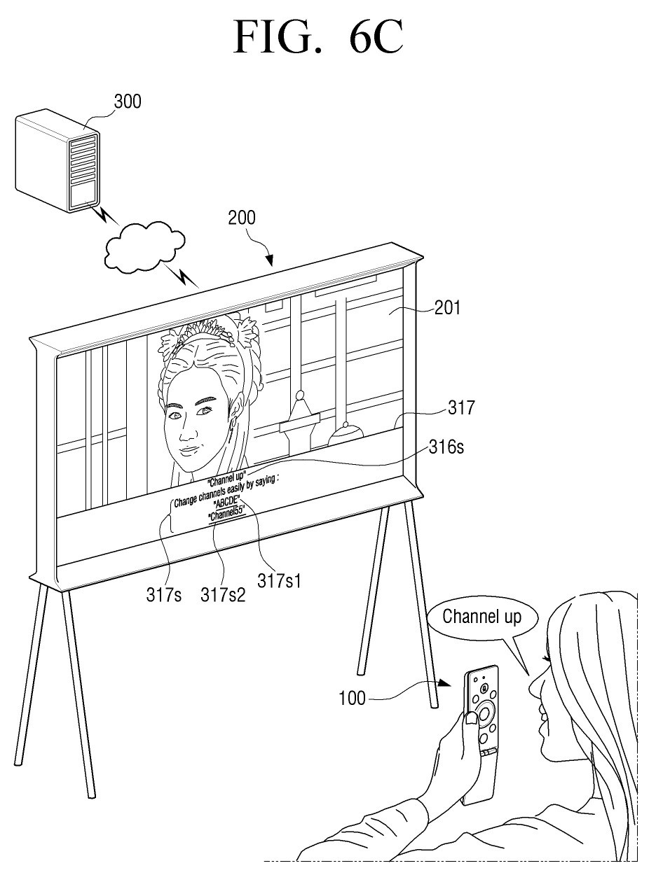

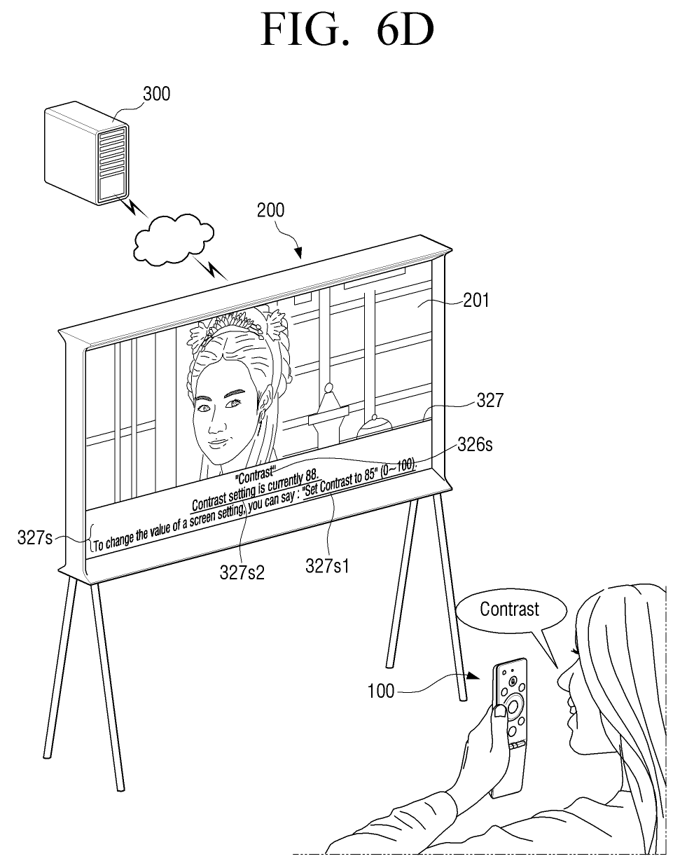

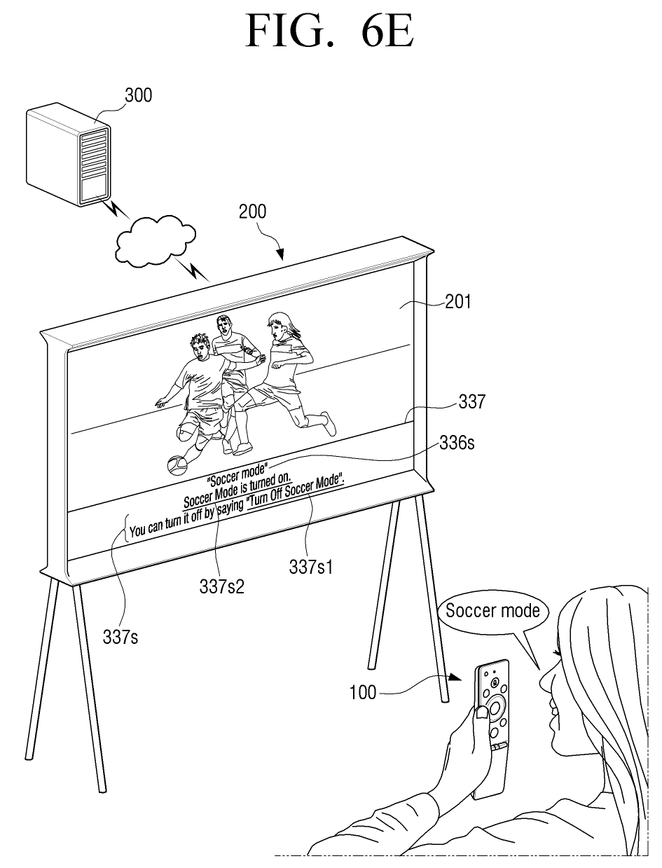

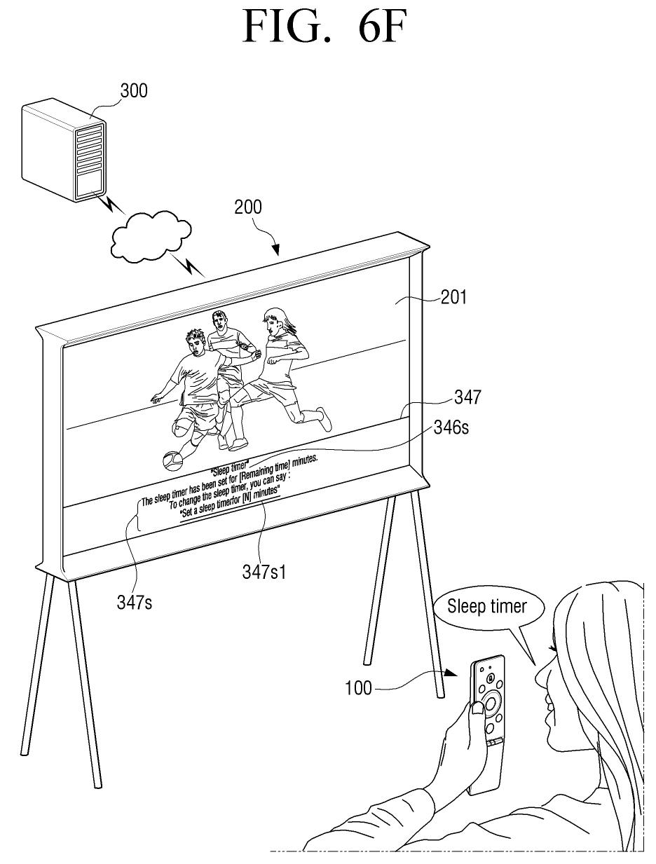

FIGS. 6A, 6B, 6C, 6D, 6E and 6F are diagrams illustrating examples regarding the method for controlling the screen of the display apparatus, according to another example embodiment.

Referring to FIG. 6A, a voice UI 307 according to another example embodiment (e.g., voice data 306s is “volume”) is displayed. By performing the operations S310, S320, S330 and S340 of FIG. 3, the user may input a user voice (e.g., volume) by using a remote control apparatus 100.

By performing the operations S350, S360, S370, S380 and S390 of FIG. 3, a processor 211 of the display apparatus 200 may display a voice UI 307 (e.g., “display a voice data (“volume”, 306s) on the voice UI) based on the voice data received from the voice recognition server 300. In addition, the processor 211 of the display apparatus 200 may receive control information that corresponds to “volume” from the voice recognition server 300 via the communicator 230.

According to the voice recognition result, prior to changing of the display apparatus 200 (or a setting of the display apparatus) (e.g., without the operation S380 being performed), the processor 211 of the display apparatus 200 may display a recommendation guide 307s on the screen based on the voice recognition result. The processor 211 of the display apparatus 200 may display the recommendation guide 307s on the voice UI 307 based on the voice recognition result.

The recommendation guide 307s may include a current setting value 307s2 and recommended voice data 307s1 of the display apparatus 200 which correspond to a voice (e.g., volume, etc.) that may be uttered by the user. The recommendation guide 307s may, for example, include “The current volume is 10. To change the volume, you can say: ‘Volume 15 (fifteen)’”. The recommended voice data (Volume 15 (fifteen), 307s1) may be randomly displayed by the processor 211 of the display apparatus 200.

In a case in which the user utters a recommended voice data (e.g., “Volume 15 (volume 15)”, 307s) in the recommendation guide (e.g., “The current volume is 10. To change the volume, you can say: ‘Volume 15 (fifteen)’”), an operation or function of the display apparatus 200 may be changed by the voice recognition by performing the operations S340, S350 and S360.

In FIG. 6A, the processor 211 of the display apparatus 200 may display a recommendation guide (not illustrated) in which a voice data (e.g., “volume”, 306s) is not displayed on the voice UI 307 based on the voice recognition result. In addition, the processor 211 of the display apparatus 200 may also display a recommendation guide (not illustrated) in which neither the voice data 306s nor the current setting value 307s2 of the display apparatus 200 is displayed on the voice UI 307 based on the voice recognition result.

Based on the voice recognition result, the processor 211 may display a visual guide (not illustrated) that corresponds to a change (e.g., “15”→“16”) of a current volume.

Referring to FIG. 6B, a voice UI 307 according to another example embodiment (e.g., a voice data 306s is “volume”) is displayed. FIG. 6B may differ in some items from FIG. 6A. For example, a current setting value 307s2 of the display apparatus 100 which corresponds to a voice (e.g., “volume”, etc.) that may be uttered by the user may not be displayed on the voice UI 307.

The processor 211 of the display apparatus 200 may display the recommendation guide 307s on the voice UI 307 based on the voice recognition result. The recommendation guide 307s may include only a recommended voice data 307s1 that corresponds to a voice (e.g., “volume”, etc.) that may be uttered by the user.

In a case in which the user utters a recommended voice data (e.g., “Volume 15”, 307s1) in the recommendation guide (e.g., “to change the volume, you can say: ‘Volume 15 (fifteen)’”), an operation or function of the display apparatus 200 may be changed by voice recognition by performance of the operations S340, S350 and S360 of FIG. 3.

Referring to FIG. 6C, a voice UI 317 according to another example embodiment (e.g., voice data 316s is “channel up”) is displayed.

By performance of the operations S310, S320, S330 and S340 of FIG. 3, the user may input a user voice (e.g., channel up) by using a remote control apparatus 100.

By performance of the operations S350, S360, S370, S380 and S390 of FIG. 3, a processor 211 of the display apparatus 200 may display a voice UI 317 (e.g., display a voice data (“channel up”, 316s) on the voice UI 317) based on the voice data received from the voice recognition server 300. In addition, the processor 211 of the display apparatus 200 may receive control information that corresponds to “channel up” from the voice recognition server 300 via the communicator 230.

The processor 211 of the display apparatus 200 may display the received voice data 316s on the voice UI 317. The voice UI 317 may include a text (e.g., “channel up”, 316s) that corresponds to the reception of the voice data.

The processor 211 of the display apparatus 200 may change (e.g., channel up) an operation or function of the display apparatus 200 based on voice data and control information being received. According to the voice recognition result, in a case in which the display apparatus 200 (or a setting of the display apparatus) being changed (e.g., channel up (or change)), the processor 211 of the display apparatus 200 may display a recommendation guide 317s on the voice UI 317 based on the voice recognition result.

The recommendation guide 317s may include a recommended voice data (at least one of 317s1 and 317s2) that corresponds to a voice (e.g., “channel up”, etc.) that may be uttered by the user. The recommendation guide 317s may, for example, include “Change channels easily by saying: ‘ABODE’, ‘Channel 55’”. The recommended voice data (“ABCDE” 317s1 and “Channel 55” 317s2) may be randomly displayed by the processor 211 of the display apparatus 200.

In a case in which the user utters one of the recommended voice data (e.g., “ABCDE” 317s1 and “Channel 55” 317s2) in the recommendation guide (e.g., “Change channels easily by saying: ‘ABCDE’, ‘Channel 55’, 317s), an operation or function of the display apparatus 200 may be changed by the voice recognition by performance of the operations S340, S350 and S360 of FIG. 3.

In FIG. 6C, the processor 211 of the display apparatus 200 may display a recommendation guide (not illustrated) in which a voice data 316s (e.g., “Channel up”) is included in the voice UI 317 based on the voice recognition result. In addition, the processor 211 of the display apparatus 200 may not display a voice data 316s based on the voice recognition result but display a recommendation guide (not illustrated) in which a current setting value (e.g., The current channel is 10, not illustrated) is displayed on the voice UI 317.

The processor 211 of the display apparatus 200 may display a visual guide (e.g., channel information including the changed channel number, channel name, and the like) on one side of the screen based on the reception of the control information. In addition, the channel information displayed on one side of the screen may include at least one from among a current channel number (e.g., “11”, not illustrated) of the current display apparatus 200 and a channel key (not illustrated) that corresponds to an increase or decrease of the channel number.

Referring to FIGS. 6A, 6B and 6C, the voice data that corresponds to a change of screen (or function) is an example embodiment that corresponds to a channel change or volume change of the display apparatus 200, and may also be implemented in an alternative example embodiment (e.g., execution of a smart hub, execution of a game, execution of an application, change of an input source, and the like) in which a screen (or channel, etc.) of the display apparatus is changed.

Referring to FIG. 6D, a voice UI 327 according to another example embodiment (e.g., voice data 326s that corresponds to settings is “contrast”) is displayed. By performance of the operations S310, S320, S330 and S340 of FIG. 3, the user may input a user voice (e.g., contrast) by using a remote control apparatus 100.

By performance of the operations S350, S360, S370, S380 and S390 of FIG. 3, a processor 211 of the display apparatus 200 may display a voice UI 327 (e.g., display a voice data 326s (“contrast”) in the voice UI 327) based on the voice data received from the voice recognition server 300. In addition, the processor 211 of the display apparatus 200 may receive control information that corresponds to “contrast” from the voice recognition server 300 via the communicator 230.

According to the voice recognition result, prior to changing of the display apparatus 200 (or a setting of the display apparatus) (e.g., without the operation S380 performed), the processor 211 of the display apparatus 200 may display a recommendation guide 327s on the screen based on the voice recognition result. The processor 211 of the display apparatus 200 may display the recommendation guide 327s on the voice UI 327 based on the voice recognition result.

The recommendation guide 327s may include a current setting value 327s2 and recommended voice data 327s1 of the display apparatus 200 which correspond to a voice (e.g., contrast, etc.) that may be uttered by the user. The recommendation guide 327s may, for example, include “Contrast is currently 88. To change the setting, you can say: ‘Set Contrast to 85’ (0-100)”. The recommended voice data (“Set Contrast to 85”, 327s1) may be randomly displayed by the processor 211 of the display apparatus 200.

In a case in which the user utters a recommended voice data (e.g., “Set Contrast to 85”, 327s1) in the recommendation guide (e.g., “Contrast is currently 88. To change the setting, you can say: ‘Set Contrast to 85’ (0-100)’, 327s), an operation or function of the display apparatus 200 may be changed by the voice recognition by performance of the operations S340, S350 and S360 of FIG. 3.

In FIG. 6D, the processor 211 of the display apparatus 200 may display a recommendation guide (not illustrated) in which a voice data 326s (e.g., “contrast”) is included in the voice UI 327 based on the voice recognition result. In addition, the processor 211 of the display apparatus 200 may also display a recommendation guide (not illustrated) in which neither the voice data 326s nor the current setting value 327s2 of the display apparatus 200 is displayed on the voice UI 327 based on the voice recognition result.

Referring to FIG. 6D, a voice data that corresponds to the voice recognition is an example embodiment that corresponds to the settings of the display apparatus 200, and may include any item (e.g., picture, sound, network, and the like) which is included in the settings of the display apparatus 200. In addition, the voice data may be implemented as separate items.

Referring to FIG. 6E, a voice UI 337 according to another example embodiment (e.g., voice data 336 that corresponds to toggling is “soccer mode”) is displayed. By performance of the operations S310, S320, S330 and S340 of FIG. 3, the user may input a user voice (e.g., contrast) by using a remote control apparatus 100.

By performance of the operations S350, S360, S370, S380 and S390 of FIG. 3, a processor 211 of the display apparatus 200 may display a voice UI 337 (e.g., display a voice data 336s (“soccer mode”) in the voice UI 337) based on the voice data received from the voice recognition server 300. In addition, the processor 211 of the display apparatus 200 may receive control information that corresponds to “soccer mode” from the voice recognition server 300 via the communicator 230.

According to the voice recognition result, after the display apparatus 200 (or a setting of the display apparatus) is changed (e.g., after the operation S380 is performed), the processor 211 of the display apparatus 200 may display a recommendation guide 337s on the screen based on the voice recognition result. The processor 211 of the display apparatus 200 may display the recommendation guide 337s on the voice UI 337 based on the voice recognition result.

The recommendation guide 337s may include a current setting value 337s2 and recommended voice data 337s1 of the display apparatus 200 which correspond to a voice (e.g., contrast, etc.) that may be uttered by the user. The recommendation guide 337s may, for example, include “Soccer mode is turned on. You can turn it off by saying: ‘Turn off soccer mode’”. The recommended voice data (“Turn off soccer mode”, 337s1) may be selectively (i.e., by toggling) displayed by the processor 211 of the display apparatus 200.

In a case in which the user utters a recommended voice data (e.g., “Turn off soccer mode”, 337s1) in the recommendation guide (e.g., “Soccer mode is turned on. You can turn it off by saying: ‘Turn off soccer mode’”, 337s1), an operation or function of the display apparatus 200 may be changed by the voice recognition by performance of the operations S340, S350 and S360 of FIG. 3.

In FIG. 6E, the processor 211 of the display apparatus 200 may display a recommendation guide (not illustrated) in which a voice data 336s (e.g., “soccer mode”) is included in the voice UI 337 based on the voice recognition result. In addition, the processor 211 of the display apparatus 200 may also display a recommendation guide (not illustrated) in which neither the voice data 336s nor the current setting value 337s2 of the display apparatus 200 is displayed on the voice UI 337 based on the voice recognition result.

Referring to FIG. 6E, the voice data that corresponds to the voice recognition is an example embodiment that corresponds to a mode change (or toggling) of the display apparatus, and may include any item (e.g., movie mode, sports mode, and the like) included in a mode change of the display apparatus 200. In addition, the voice data may be implemented as separate items.

Referring to FIG. 6F, a voice UI 347 according to another example embodiment (e.g., voice data 346 is “Sleep timer”) is displayed. By performance of the operations S310, S320, S330 and S340 of FIG. 3, the user may input a user voice (e.g., Sleep timer) by using a remote control apparatus 100.

By performance of the operations S350, S360, S370, S380 and S390 of FIG. 3, a processor 211 of the display apparatus 200 may display a voice UI 347 (e.g., display a voice data 346s (“Sleep timer”) in the voice UI 347) based on the voice data received from the voice recognition server 300. In addition, the processor 211 of the display apparatus 200 may receive control information that corresponds to “sleep timer” from the voice recognition server 300 via the communicator 230.

According to the voice recognition result, without changing of the display apparatus 200 (or a setting of the display apparatus), (e.g., the operation S380 is performed), the processor 211 of the display apparatus 200 may display a recommendation guide 347s on the screen based on the voice recognition result. The processor 211 of the display apparatus 200 may display the recommendation guide 347s on the voice UI 347 based on the voice recognition result.

The recommendation guide 347s may include a recommended voice data 347s1 that corresponds to a voice (e.g., Sleep timer, etc.) that may be uttered by the user. The recommendation guide 347s may, for example, include “The sleep timer has been set for [remaining time] minutes. To change the sleep timer, you can say: ‘Set a sleep timer for [N] minutes’.” The recommended voice data (“Set a sleep timer for [N] minutes”, 347s1) may be displayed by the processor 211 of the display apparatus 200.

In a case in which the user utters a recommended voice data (e.g., “Set a sleep timer for [N] minutes”, 347s1) in the recommendation guide (e.g., “The sleep timer has been set for [remaining time] minutes. To change the sleep timer, you can say: ‘Set a sleep timer for [N] minutes’, 347s), an operation or function of the display apparatus 200 may be changed by the voice recognition by performance of the operations S340, S350 and S360 of FIG. 3.

In FIG. 6F, the processor 211 of the display apparatus 200 may display a recommendation guide (not illustrated) in which a voice data 346s (e.g., “sleep timer”) is included in the voice UI 347 based on the voice recognition result.

At operation S390 of FIG. 3, in a case in which a recommendation guide is displayed on the voice UI based on the voice recognition result, a content displaying method of a display apparatus is ended.

The methods according to exemplary embodiments of the present disclosure may be implemented as a program instruction type that may be performed by using any of various computer components and may be recorded in a non-transitory computer readable medium. The computer-readable medium may include a program command, a data file, a data structure or the like, alone or a combination thereof. For example, the computer-readable medium may be stored in a volatile or non-volatile storage device such as a ROM, a memory such as a RAM, a memory chip, and a device or an integrated circuit, or a storage medium which may be read with a machine (e.g., central processing unit (CPU)) simultaneously with being optically or magnetically recorded such as, for example, a compact disk (CD), a digital versatile disk (DVD), a magnetic disk, a magnetic tape, or the like, regardless of whether it is deleted or again recorded. The memory which may be included in a display apparatus may be one example of a storage medium which may be read with programs including instructions implementing the exemplary embodiments of the present disclosure or a machine appropriate to store the programs. The program commands recorded in the computer-readable medium may be designed for the exemplary embodiments or be known to persons having ordinary skill in a field of computer software.

Although several exemplary embodiments have been disclosed for illustrative purposes, persons having ordinary in the art will appreciate that various modifications, additions and substitutions are possible, without departing from the scope and spirit thereof as disclosed in the accompanying claims.

Accordingly, the scope of the present disclosure is not construed as being limited to the disclosed embodiments but is defined by the appended claims as well as equivalents thereto.

What is claimed is:

1. A display apparatus, comprising:
a display;
a communication interface; and
a processor configured to control the display and the communication interface,
wherein the processor is further configured to:
control the communication interface to, based on receiving a signal that corresponds to a user voice from the remote controller, transmit the signal to the voice recognition server, and
based on receiving a voice recognition result that relates to the user voice from the voice recognition server through the communication interface, perform an operation that corresponds to the voice recognition result, and
control the display to display a recommendation guide that provides guidance for performing a voice control method related to the operation.

2. The display apparatus as claimed in claim 1, further comprising a storage,
wherein the processor is further configured to determine the recommendation guide based on history information stored in the storage, the history information corresponds to a voice utterance history for at least one user.

3. The display apparatus as claimed in claim 2, wherein the processor is further configured to, based on a same voice recognition result being received from the voice recognition server, control the display to display another recommendation guide according to an authenticated user based on the history information.

4. The display apparatus as claimed in claim 2, wherein the processor is further configured to control the display to display a first voice user interface based on a reception of a signal that corresponds to the user voice, a second voice user interface based on a transmission of the received signal to the voice recognition server, and a third voice user interface based on a reception of the voice recognition result.

5. The display apparatus as claimed in claim 1, further comprising a microphone,
wherein the processor is further configured to control the communication interface to transmit a signal that corresponds to a user voice which is received via the microphone to the voice recognition server.

6. The display apparatus as claimed in claim 1, wherein the processor is further configured to control the display to display a voice user interface distinctively with respect to contents displayed on the display.

7. The display apparatus as claimed in claim 1, wherein the processor is further configured to control the display to display a first voice user interface based on a reception of a signal that corresponds to the user voice, a second voice user interface based on a transmission of the received signal to the voice recognition server, and a third voice user interface based on a reception of the voice recognition result.

8. A method for displaying a screen of a display apparatus, the method comprising:
displaying a first voice user interface that corresponds to a selection of a voice button received from a remote controller;
receiving a signal that corresponds to a user voice from the remote controller;
transmitting a packet that corresponds to the received signal to a voice recognition server;
displaying a second voice user interface that corresponds to a voice recognition result received from the voice recognition server;
performing an operation that corresponds to the voice recognition result; and
displaying a recommendation guide that provides guidance for performing a voice control method related to the operation.

9. The method as claimed in claim 8, wherein the recommendation guide is displayed on one side of the screen of the display apparatus.

10. The method as claimed in claim 8, further comprising:
determining the recommendation guide based on history information that corresponds to a pre-stored voice utterance history of a user.

11. The method as claimed in claim 8, wherein the recommendation guide is provided variably based on an authenticated user.

12. The method as claimed in claim 8, wherein the first voice user interface, the second voice user interface and the recommendation guide are displayed in an overlapping manner with respect to a content displayed on the display apparatus.

13. A display apparatus, comprising:
a display;
a communication interface; and
a processor configured to control the display and the communication interface,
wherein the processor is further configured to:
based on the communication interface receiving a user voice signal from the remote controller, obtain a voice recognition result by executing a voice recognition algorithm with respect to the received user voice signal,
perform an operation that corresponds to the voice recognition result, and
control the display to display a recommendation guide that provides guidance for performing a voice control method related to the operation.

14. The display apparatus as claimed in claim 13, further comprising:
a storage,
wherein the processor is further configured to determine the recommendation guide based on history information stored in the storage, the history information corresponds to a voice utterance history for at least one user.

15. The display apparatus as claimed in claim 13, wherein based on the received user voice signal relating to a volume increase or a volume decrease and the operation relating to a corresponding change of volume, the recommendation guide includes guidance for setting a volume to a numerical level selected by a user.

16. The display apparatus as claimed in claim 13, wherein based on the received user voice signal relating to a channel increase or a channel decrease and the operation relating to a corresponding change of channel, the recommendation guide includes guidance for setting a channel to a numerical value selected by a user.
